(19) United States
(12) Patent Application Publication
(10) Pub. No.: US 2026/0187531 A1
(43) Pub. Date: Jul. 2, 2026

(54) System and Method for Spectral Learning in Cognitive Manifolds

(71) Applicant: AtomBeam Technologies Inc., Moraga, CA (US)

(72) Inventor: Brian Galvin, Silverdale, WA (US)

(21) Appl. No.: 19/533,058

(22) Filed: Feb. 6, 2026

Related U.S. Application Data
(63) Continuation-in-part of application No. 19/393,493, filed on Nov. 18, 2025.
Application No. 19/393,493 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.
(60) Provisional application No. 63/879,580, filed on Sep. 10, 2025.

(51) Int. Cl. G06N 20/00; G06N 5/04

(52) U.S. Cl. CPC G06N 20/00; G06N 5/04

(57) ABSTRACT

A system and method for spectral learning in persistent cognitive machines implements learning through controlled evolution of a spectral decomposition of a cognitive manifold. The spectral decomposition, comprising eigenvectors and eigenvalues, encodes long-term memory as global geometric structure rather than as stored data or network parameters. The system performs inference operations by projecting incoming data onto the cognitive manifold using a fixed spectral decomposition without modification. Geometric invariants including principal angles, spectral gap ratios, projection residuals, and curvature statistics are continuously monitored to detect structural inadequacy. When invariants exceed thresholds, a learning event modifies the spectral decomposition through eigen decomposition with warm-start initialization while enforcing mode-specific plasticity bounds that are tighter for low-frequency eigenvectors than high-frequency eigenvectors, thereby preventing catastrophic forgetting. The system operates continuously by alternating between inference using fixed spectral decompositions and learning events that modify spectral decompositions through controlled spectral evolution.

### CROSS-REFERENCE TO RELATED APPLICATIONS

Priority is claimed in the application data sheet to the following patents or patent applications, each of which is expressly incorporated herein by reference in its entirety:
Ser. No. 19/393,493
63/879,580
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention is in the field of computational geometry and machine learning for manifold-based representation learning, and more particularly to adaptive geometric diffusion systems and methods that project heterogeneous, streaming latent states onto a shared low-dimensional Riemannian manifold.

### Discussion of the State of the Art

Contemporary artificial intelligence systems implement learning through modification of internal parameters, such as weights of neural networks, optimized via gradient descent on training data. While effective within bounded training regimes, such parameter-centric approaches exhibit fundamental limitations for persistent cognitive systems. In particular, these systems lack intrinsic mechanisms for preserving global semantic structure under continuous operation, suffer from catastrophic forgetting when exposed to non-stationary data distributions, and require episodic retraining or continual fine-tuning to maintain coherence. Without replay buffers or specialized regularization, parameter updates risk overwriting previously learned knowledge, and loss-based monitoring provides only heuristic signals about representational degradation.

Classical spectral methods for manifold learning, such as Laplacian eigenmaps and diffusion maps, provide geometry-first dimensionality reduction by computing eigenvector coordinates from graph Laplacians. However, these methods treat the spectral decomposition as a static computational artifact produced once or infrequently through batch processing. They do not define learning as an ongoing process of spectral evolution, provide no principled mechanisms for adapting the spectral basis under streaming data or distributional drift, and lack stability constraints to prevent catastrophic forgetting during incremental updates. When deployed in persistent systems, classical spectral methods require complete recomputation to incorporate new structure, making them unsuitable for continuous long-horizon operation.

Token-centric memory architectures, including retrieval-augmented generation and attention-based systems, store experience as discrete artifacts that must be explicitly retrieved or replayed during inference. Such approaches scale poorly with accumulated experience, provide limited guarantees of semantic consistency over long horizons, and require careful management of memory buffers to balance capacity with relevance. These systems represent memory as collections of stored items rather than as durable geometric constraints that implicitly guide future reasoning.

Incremental or online spectral methods exist in the literature but focus on computational efficiency of updating eigen decompositions rather than on learning as a cognitive process. These methods do not distinguish between inference operations that use a fixed spectral basis and learning operations that modify it, do not enforce differential plasticity constraints across spectral modes to protect foundational knowledge, and do not provide geometric invariants for detecting when updates are necessary. The field lacks a learning paradigm in which the spectral decomposition itself constitutes persistent memory and its controlled evolution constitutes learning.

What is needed is a system and method that realizes learning through controlled evolution of a spectral decomposition of a cognitive manifold, where the spectral decomposition encodes long-term memory as global geometric structure rather than as stored data or network parameters. The system should distinguish inference operations that use a fixed spectral decomposition from learning operations that modify it through bounded spectral evolution. The system should enforce mode-specific plasticity constraints that protect low-frequency eigenvectors encoding foundational structure while permitting adaptation in high-frequency eigenvectors encoding local detail, thereby preventing catastrophic forgetting.

### SUMMARY OF THE INVENTION

Accordingly, the inventor has conceived and reduced to practice, a system and method for spectral learning in persistent cognitive machines implements learning through controlled evolution of a spectral decomposition of a cognitive manifold. The spectral decomposition, comprising eigenvectors and eigenvalues, encodes long-term memory as global geometric structure rather than as stored data or network parameters. The system performs inference operations by projecting incoming data onto the cognitive manifold using a fixed spectral decomposition without modification. Geometric invariants including principal angles, spectral gap ratios, projection residuals, and curvature statistics are continuously monitored to detect structural inadequacy. When invariants exceed thresholds, a learning event modifies the spectral decomposition through eigendecomposition with warm-start initialization while enforcing mode-specific plasticity bounds that are tighter for low-frequency eigenvectors than high-frequency eigenvectors, thereby preventing catastrophic forgetting. The system operates continuously by alternating between inference using fixed spectral decompositions and learning events that modify spectral decompositions through controlled spectral evolution.

According to a preferred embodiment, a spectral learning system for a persistent cognitive machine is disclosed, comprising: a processor; and a memory storing instructions that, when executed by the processor, cause the system to: maintain a spectral decomposition of a cognitive manifold, the spectral decomposition comprising eigenvectors and eigenvalues that encode persistent long-term memory as global geometric structure; perform inference operations by projecting incoming data onto the cognitive manifold using the spectral decomposition without modifying the spectral decomposition; monitor geometric invariants that quantify structural adequacy of the spectral decomposition; in response to a geometric invariant exceeding a threshold, execute a learning event comprising: performing eigendecomposition of a graph Laplacian using warm-start initialization from the spectral decomposition; enforcing mode-specific plasticity bounds that are tighter for low-frequency eigenvectors than for high-frequency eigenvectors; and when the plasticity bounds are satisfied, replacing the spectral decomposition with an updated spectral decomposition; and operate continuously by alternating between inference operations using a fixed spectral decomposition and learning events that modify the spectral decomposition through controlled spectral evolution, wherein learning is realized through the controlled spectral evolution of the spectral decomposition.

According to another preferred embodiment, a computer-implemented method for spectral learning in a persistent cognitive machine is disclosed, comprising the steps of: maintaining a spectral decomposition of a cognitive manifold, the spectral decomposition comprising eigenvectors and eigenvalues that encode persistent long-term memory as global geometric structure; performing inference operations by projecting incoming data onto the cognitive manifold using the spectral decomposition without modifying the spectral decomposition; monitoring geometric invariants that quantify structural adequacy of the spectral decomposition; in response to a geometric invariant exceeding a threshold, executing a learning event comprising: performing eigendecomposition of a graph Laplacian using warm-start initialization from the spectral decomposition; enforcing mode-specific plasticity bounds that are tighter for low-frequency eigenvectors than for high-frequency eigenvectors; and when the plasticity bounds are satisfied, replacing the spectral decomposition with an updated spectral decomposition; and operating continuously by alternating between inference operations using a fixed spectral decomposition and learning events that modify the spectral decomposition through controlled spectral evolution; wherein learning is realized through the controlled spectral evolution of the spectral decomposition.

According to a further aspect, the method includes geometric invariants comprising at least one of: principal angles between the spectral decomposition and a previous spectral decomposition, spectral gap ratios computed from the eigenvalues, projection residuals measuring quality of the projection, or curvature statistics of the cognitive manifold.

According to a further aspect, the method includes performing inference operations by: identifying landmark points near the incoming data based on a semantic distance metric; computing weights based on the semantic distances; and calculating manifold coordinates as a weighted combination of spectral coordinates of the identified landmark points.

According to a further aspect, the method includes the learning event further comprising: updating a set of landmark points by promoting new landmarks from regions having high projection residuals; and constructing the graph Laplacian from semantic relationships among the updated landmark points.

According to a further aspect, the method includes enforcing the mode-specific plasticity bounds by: computing principal angles between updated eigenvectors and the eigenvectors of the spectral decomposition; comparing the principal angles against a maximum rotation threshold; and rejecting the updated eigenvectors when the principal angles exceed the maximum rotation threshold.

According to a further aspect, the method includes enforcing the mode-specific plasticity bounds by: computing eigenvalue drift magnitudes as differences between updated eigenvalues and the eigenvalues of the spectral decomposition; comparing each eigenvalue drift magnitude against a mode-specific drift threshold; and rejecting updated eigenvalues when eigenvalue drift for any low-frequency eigenvector exceeds a corresponding tight drift threshold.

According to a further aspect, the method includes the learning event further comprising: computing an alignment transformation between the spectral decomposition and the updated spectral decomposition; and transforming previously computed manifold coordinates using the alignment transformation to maintain continuity of geometric relationships.

According to a further aspect, the method includes receiving incoming data from a plurality of heterogeneous source spaces corresponding to different modalities; maintaining separate semantic distance metrics for each modality; and computing modality-specific projections that are combined based on reliability weights.

According to a further aspect, the method includes encoding the persistent long-term memory as global geometric structure without requiring storage of individual data points or training examples.

### BRIEF DESCRIPTION OF THE DRAWING FIGURES

FIG. 1 is a block diagram illustrating the integration of an adaptive geometric diffusion projection system within a persistent cognitive machine architecture, according to an embodiment.

FIG. 2 is a block diagram illustrating an exemplary system architecture for an adaptive geometric diffusion projection system, according to an embodiment.

FIG. 3 is a flow diagram illustrating an exemplary method for adaptive geometric diffusion projection onto manifolds, according to an embodiment.

FIG. 4 is a flow diagram illustrating an exemplary method for landmark management and spectral update within the adaptive geometric diffusion system, according to an embodiment

FIG. 5 is a flow diagram illustrating an exemplary method for harmonic extension enabling streaming attachment of new points to the manifold, according to an embodiment.

FIG. 6 is a flow diagram illustrating an exemplary method for compression flow refinement of manifold coordinates, according to an embodiment.

FIG. 7 is a flow diagram illustrating an exemplary method for drift monitoring and adaptive response within the adaptive geometric diffusion system, according to an embodiment.

FIG. 8 is a flow diagram illustrating an exemplary method for multimodal fusion within the adaptive geometric diffusion system, according to an embodiment.

FIG. 9 illustrates an exemplary computing environment on which an embodiment described herein may be implemented.

FIG. 10 is a block diagram illustrating an exemplary system architecture for a spectral learning system, according to an embodiment.

FIG. 11 is a flow diagram illustrating an exemplary method for spectral learning event execution within an adaptive spectral learning system, according to an embodiment.

FIG. 12 is a flow diagram illustrating an exemplary method for inference-learning decision within an adaptive spectral learning system, according to an embodiment.

FIG. 13 is a flow diagram illustrating an exemplary method for spectral plasticity control within an adaptive spectral learning system, according to an embodiment.

### DETAILED DESCRIPTION OF THE INVENTION

The inventor has conceived, and reduced to practice, a system and method for spectral learning in persistent cognitive machines implements learning through controlled evolution of a spectral decomposition of a cognitive manifold. The spectral decomposition, comprising eigenvectors and eigenvalues, encodes long-term memory as global geometric structure rather than as stored data or network parameters. The system performs inference operations by projecting incoming data onto the cognitive manifold using a fixed spectral decomposition without modification. Geometric invariants including principal angles, spectral gap ratios, projection residuals, and curvature statistics are continuously monitored to detect structural inadequacy. When invariants exceed thresholds, a learning event modifies the spectral decomposition through eigendecomposition with warm-start initialization while enforcing mode-specific plasticity bounds that are tighter for low-frequency eigenvectors than high-frequency eigenvectors, thereby preventing catastrophic forgetting. The system operates continuously by alternating between inference using fixed spectral decompositions and learning events that modify spectral decompositions through controlled spectral evolution.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “cognitive manifold” refers to a low-dimensional geometric structure onto which heterogeneous, high-dimensional latent representations are projected for the purpose of persistent cognition. The cognitive manifold is characterized by neighborhoods, trajectories, curvature, and continuity, and supports geometric operations such as distance measurement, geodesic transport, and local tangent approximation. The cognitive manifold may be extended across time, modalities, and computational sites, forming an extended or federated manifold that represents the accumulated semantic structure of the system's experience.

As used herein, “geometric invariants” refer to measurable quantities that remain stable (or are constrained to remain stable) under normal inference operation and that can be evaluated to detect structural changes in the cognitive manifold. Geometric invariants may include, without limitation, curvature signatures, diffusion entropy, spectral gaps, eigenvalue stability, neighborhood density statistics, or trajectory recurrence metrics. Geometric invariants can be used for detecting learning-relevant events and for triggering spectral learning operations.

As used herein, “geometric reasoning” refers to cognitive operations realized as motion, transport, or traversal on the cognitive manifold. Reasoning trajectories are constrained by the manifold's geometry, which is determined by the spectral basis. Accordingly, geometric reasoning operates directly on spectral memory and evolves naturally as spectral learning modifies the manifold structure.

As used herein, “inference” refers to operations that place new data into an existing cognitive manifold and generate outputs using a fixed spectral basis, such as by harmonic extension, diffusion-based propagation, geodesic traversal, or spectral-coordinate evaluation. As used herein, “learning” refers to operations that modify the cognitive manifold's spectral decomposition, including updating landmarks, refreshing eigenvectors/eigenvalues, or re-estimating spectral coordinates, typically in response to invariant-triggering events. This separation of inference from learning supports stable, long-horizon cognition.

As used herein, “landmarks” refer to selected representative points, states, or exemplars of the cognitive manifold used to define or approximate the diffusion operator and its spectral decomposition. Landmarks serve as stable reference points for harmonic extension, spectral updates, and learning credit assignment. Promotion, retention, or removal of landmarks influences the substrate on which spectral learning operates.

As used herein, “Persistent Cognitive Machine” or “PCM” refers to a computing system that maintains persistent cognitive processes regardless of external interaction, can remember previous experiences, learn from these experiences, create new thought experiences independently, and initiate interactions without waiting for external prompts. Unlike traditional AI systems that operate within a prompt-response paradigm, a PCM operates with persistent awareness even when not actively engaged with users or external systems.

As used herein, “spectral decomposition” refers to the eigenvalue-eigenvector decomposition of a diffusion operator, graph Laplacian, or analogous operator defined on landmarks or representative points of the cognitive manifold. The resulting set of eigenvectors defines a spectral basis, and the associated eigenvalues characterize global structural properties of the manifold. The spectral basis provides a global coordinate system for the cognitive manifold and governs harmonic extension, diffusion behavior, and long-range semantic relationships.

As used herein, “spectral learning” refers to a learning paradigm in which long-term learning is realized through controlled modification of the spectral decomposition of an adaptive cognitive manifold. In spectral learning, learning events correspond to bounded changes in eigenvalues, eigenvectors, spectral gaps, or derived spectral coordinates associated with a diffusion operator defined on the manifold. Spectral learning is distinct from parameter learning, representation learning, and metric learning. Unlike parameter learning, spectral learning does not update weights of a parametric model via gradient descent. Unlike representation learning, spectral learning does not merely map data into a fixed latent space. Unlike metric learning, spectral learning does not only adjust distance functions while holding global structure fixed. Instead, spectral learning modifies the global geometric structure itself in a controlled and invariant-governed manner.

As used herein, “spectral memory” refers to the encoding of long-term semantic structure in the eigenvalues, eigenvectors, and derived spectral coordinates of the cognitive manifold. Spectral memory is persistent across input queries and provides a stable substrate for inference operations. Spectral memory evolves only through spectral learning events.

As used herein, “spectral plasticity” refers to the bounded adaptability of spectral memory over time. Spectral plasticity may be constrained by invariant thresholds, eigenvalue drift bounds, eigenspace alignment limits, or spectral stability criteria, thereby preserving semantic continuity and preventing catastrophic forgetting.

As used herein, “thought” refers to a discrete unit of cognition within the persistent cognitive machine, representing information, concepts, observations, inferences, questions, or other cognitive elements that the system processes and stores. Thoughts may be derived from external inputs, generated through internal reasoning processes, or created through recombination of existing thoughts.

As used herein, “thought cache” refers to the component of the persistent cognitive machine that stores, organizes, and provides access to thoughts. The thought cache may include both short-term and long-term storage capabilities, with mechanisms for transferring information between them and organizing thoughts based on semantic relationships.

As used herein, “sleep state” refers to a mode of operation in which the persistent cognitive machine temporarily reduces responsiveness to external stimuli to focus on internal cognitive maintenance processes, including but not limited to memory consolidation, thought generalization, insight generation, and memory reorganization.

### Conceptual Architecture

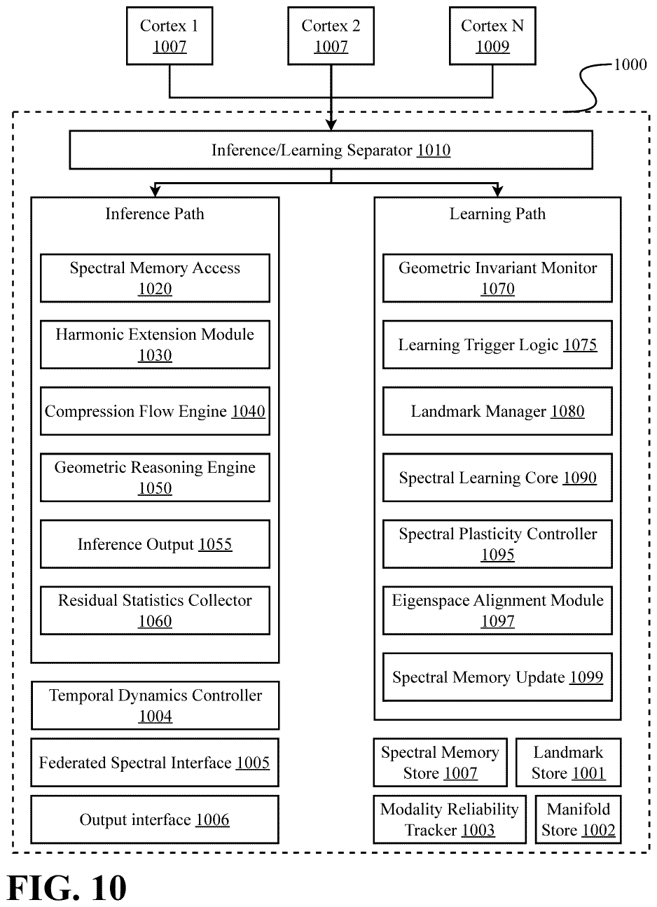

FIG. 10 is a block diagram illustrating an exemplary system architecture for a spectral learning system, according to an embodiment. The spectral learning system 1000 represents a fundamental advancement in learning architectures for persistent cognitive machines by implementing learning as controlled evolution of spectral decomposition rather than as parameter optimization. Spectral learning system 1000 realizes learning through bounded modifications of the eigenvalues and eigenvectors associated with a cognitive manifold, thereby encoding long-term memory directly in geometric structure rather than in weights or tokens. This architecture enables stable, long-horizon learning under distributional drift, multimodal input, and federated operation without requiring retraining or suffering from catastrophic forgetting.

At the architectural level, spectral learning system 1000 operates as an integrated component within a broader persistent cognitive machine platform, receiving heterogeneous inputs from multiple cortical sources and producing unified geometric representations that support both inference and reasoning. The system enforces a strict architectural separation between inference operations, which operate on a fixed spectral basis without modifying long-term memory, and learning operations, which modify the spectral basis itself and thereby update the system's persistent memory structure. This separation enables the system to maintain stable cognition during ongoing operation while selectively incorporating structural novelty through principled spectral evolution.

According to the embodiment, spectral learning system 1000 receives input from a plurality of cortices, shown as cortex 1(1007), cortex 2(1008), through cortex N (1009), each producing latent representations in distinct high-dimensional spaces denoted as S^{j}. These cortices may operate in different modalities such as visual processing, auditory analysis, linguistic understanding, temporal reasoning, or other specialized cognitive domains. Each cortex generates latent states with its own dimensional characteristics, distributional properties, and semantic structure. The heterogeneity of these inputs presents a fundamental challenge for unified representation, as conventional learning systems typically require homogeneous inputs or force all modalities through a common parameterized embedding that may lose modality-specific semantic structure.

Input streams from the multiple cortices pass to an inference/learning separator 1010, which represents an architectural decision point in the spectral learning system. Separator 1010 routes incoming data to either the inference path or the learning path based on signals received from geometric invariant monitoring components. During normal operation, the vast majority of inputs are routed to the inference path, where they are processed using the current, fixed spectral memory without modification. Only when monitored geometric invariants indicate structural novelty, capacity saturation, or semantic drift does separator 1010 route information to the learning path for spectral modification. This routing mechanism implements the fundamental distinction between inference, which uses existing memory, and learning, which creates or modifies memory. Separator 1010 receives control signals from a geometric invariant monitor 1070, which continuously tracks metrics such as principal angles, spectral gaps, curvature statistics, and projection residuals to determine when learning is warranted.

The left portion of the architecture comprises the inference path, which operates on fixed spectral memory and performs no learning. At the top of the inference path, a spectral memory access component 1020 provides read-only access to the current spectral basis, including the eigenvectors and eigenvalues that define the global geometry of the cognitive manifold. This component ensures that all inference operations utilize a consistent, stable spectral basis, preventing the geometric instability that would arise if different operations observed different memory states. Spectral memory access 1020 retrieves spectral information from the central spectral memory store 1007 but does not permit modifications, thereby enforcing the read-only constraint that characterizes inference operations.

Proceeding down the inference path, a harmonic extension module 1030 implements one or more mechanisms for attaching new data points to the existing cognitive manifold without global recomputation. When a new point x arrives from cortex j, harmonic extension module 1030 queries the L nearest landmarks in the modality-specific semantic metric, computes interpolation weights according to an exponential kernel with a bandwidth parameter, and calculates a weighted barycenter of the landmark spectral coordinates. Mathematically, the harmonic extension computes weights where the sum is over the L nearest landmarks, and assigns spectral coordinates. This weighted barycentric interpolation provides a closed-form solution to the discrete Dirichlet problem of finding coordinates that are harmonic with respect to the boundary conditions imposed by nearby landmarks. Harmonic extension module 1030 operates in constant time relative to the total number of stored experiences, enabling true streaming operation with bounded computational complexity.

The coordinates produced by harmonic extension module 1030 represent a principled first approximation of the new point's position on the cognitive manifold. However, local geometric inconsistencies may accumulate without further refinement. A compression flow engine 1040 refines these initial coordinates through constrained gradient descent on a geometric energy functional that balances multiple objectives. The energy functional includes a semantic coherence term that encourages semantically similar points to remain close on the manifold, a curvature penalty term that discourages excessive local curvature that could lead to folding, a density regularization term that promotes uniform sampling density across the manifold, and a chart conditioning term that ensures local coordinate charts remain well-conditioned. Compression flow engine 1040 computes the gradient of this energy functional, projects the gradient onto the local tangent space estimated from neighboring manifold points to ensure updates remain on the manifold, and updates coordinates through small steps bounded by local geometric constraints. The compression flow operates only on local neighborhoods affected by new input points, maintaining the logarithmic scaling property of the overall system. The refinement process typically requires only one or two iterations to achieve satisfactory local geometry, and the updates modify only the coordinates of nearby points without altering the spectral basis itself.

Following coordinate refinement, a geometric reasoning engine 1050 implements cognitive operations as motion on the cognitive manifold. Reasoning is not realized through symbolic manipulation or token retrieval, but through geometric processes operating directly on the manifold structure. A thought corresponds to a point or distribution on the manifold, and a sequence of reasoning steps corresponds to a trajectory. Engine 1050 computes geodesic paths representing minimum-cost reasoning trajectories, performs parallel transport to implement analogical reasoning across different regions of the manifold, and projects onto low-frequency spectral modes to achieve abstraction. Because the manifold geometry is determined by the spectral basis, geometric reasoning operates directly on spectral memory. As the spectrum evolves through learning, the permissible directions, costs, and stability of reasoning trajectories evolve accordingly, enabling improvements in reasoning capability to emerge naturally from spectral learning without additional symbolic machinery or explicit training of reasoning procedures.

The inference path produces manifold coordinates as inference output 1055, which are made available to downstream components of the persistent cognitive machine such as thought caches, executive control systems, and higher-level reasoning modules. These coordinates provide a unified geometric representation that preserves semantic relationships across all input modalities while enabling efficient similarity computation, trajectory planning, and other geometric operations. Importantly, the inference output represents the system's current understanding mapped onto existing memory structure, without modification of that structure.

Throughout the inference path, a residual statistics collector 1060 computes and aggregates quality metrics that feed into the drift monitoring system. For each harmonic extension operation, collector 1060 computes the residual which quantifies how well the new point can be represented by interpolation from existing landmarks. High residuals indicate regions of the latent space that are poorly covered by the current landmark set and may require landmark promotion. Residual statistics collector 1060 maintains streaming statistical summaries including means, variances, quantiles, and spatial distributions of residuals across different time windows and modalities. These statistics are continuously transmitted to geometric invariant monitor 1070 in the learning path, providing one of several signals that may trigger spectral learning operations. The collection process is designed to have minimal overhead, piggybacking on computations already performed during normal inference operations.

The right portion of the architecture comprises the learning path, which modifies spectral memory itself and thereby implements learning in the system. At the top of the learning path, geometric invariant monitor 1070 serves as the primary detection mechanism for learning-relevant events. Monitor 1070 continuously computes and tracks several key geometric invariants that characterize the health and adequacy of the current spectral memory. Principal angles between successive spectral bases are computed through singular value decomposition of the inner products between current and previous eigenvector matrices. Large principal angles indicate that the landmark geometry has rotated significantly, suggesting that accumulated gap indicates that the current dimensionality is no longer adequate to separate signal from noise, suggesting capacity saturation. Curvature statistics may be aggregated across the manifold to detect pathological geometric distortions. Injectivity radius estimates based on minimum neighbor distances ensure that the manifold maintains local homeomorphism. The residual statistics from the inference path are analyzed to identify systematic coverage degradation. Each of these invariants is compared against predetermined thresholds that are set based on theoretical requirements for manifold regularity, empirical stability boundaries, and adaptive percentiles of historical values.

When any monitored invariant exceeds its critical threshold, geometric invariant monitor 1070 signals a learning trigger logic component 1075, which categorizes the type of drift observed and routes the learning operation to the appropriate subsystem. The learning trigger logic 1075 implements threshold evaluation across multiple invariant types and determines whether learning should proceed through spectral refresh, landmark promotion, parameter adjustment, or a combination thereof. The categorization considers patterns across multiple indicators, temporal ordering of violations, and severity scores to distinguish between different drift scenarios such as spectral rotation, coverage degradation, geometric distortion, or modality drift. This intelligent routing ensures that learning responses are targeted and appropriate rather than applying generic updates regardless of the underlying cause.

A landmark manager 1080 controls the substrate upon which spectral learning operates by adaptively maintaining the set of representative points that anchor the diffusion operator and spectral decomposition. In some aspects, landmark manager 1080 implements two complementary operations: promotion of new landmarks and removal of underutilized landmarks. When the learning trigger logic 1075 signals coverage degradation based on high residual statistics, landmark manager 1080 identifies high-residual regions through spatial analysis of accumulated residuals, selects candidate points from these regions based on centrality, stability, and representativeness criteria, and promotes selected candidates to the landmark set L. This promotion expands the substrate on which the spectral decomposition is computed, enabling improved coverage of previously under-represented regions. Conversely, landmark manager 1080 continuously monitors utilization statistics for existing landmarks, tracking how often each landmark appears among nearest neighbors during harmonic extension and with what average weight it contributes to interpolations. Landmarks that consistently show low utilization may be candidates for removal, helping to maintain a compact and efficient landmark set. Landmark manager 1080 implements conservative removal procedures that verify adequate coverage will be maintained before removing any landmark. Because only landmarks participate directly in construction of the diffusion operator, changes to the landmark set are the only means by which new experiences can influence the spectral basis. This provides a form of geometric credit assignment, where learning influence can be attributed to specific promoted landmarks and regions of the cognitive manifold.

According to the embodiment, a spectral learning core 1090 implements the controlled evolution of spectral memory that constitutes learning as described herein. When the landmark set has been modified by landmark manager 1080, or when other learning signals indicate the need for spectral refresh, spectral learning core 1090 updates the kernel matrix K on the current landmark set, where the sum is over all modalities m with corresponding semantic distance functions and reliability weights. From this updated kernel, spectral learning core 1090 computes a normalized graph Laplacian with a diagonal degree matrix with entries. The spectral learning core 1090 then performs eigenvalue decomposition of the Laplacian to obtain eigenpairs. In some aspects, this decomposition is warm-started using the previous eigenvectors as initial conditions for the iterative eigensolver, typically (but not necessarily) a Lanczos or locally optimal block preconditioned conjugate gradient (LOBPCG) method. The warm-start procedure projects previous eigenvectors onto the space of the updated Laplacian and orthonormalizes them to provide excellent initial iterates. Because landmark changes are typically small relative to the total landmark set size, the projected vectors are usually close to the true eigenvectors of the updated Laplacian, enabling rapid convergence with an order of magnitude fewer iterations compared to cold-start initialization. Spectral learning core 1090 monitors convergence through residual norms and eigenvalue stability, terminating iteration when specified tolerances are achieved. Following convergence, the top m eigenvectors are extracted based on spectral gap analysis, with the selection of m guided elected eigenvectors form the updated spectral basis which replaces the previous basis and defines the new spectral memory. This modification of eigenvalues and eigenvectors represents learning as described herein, fundamentally distinguishing it from parameter-based learning systems where learning modifies weights through gradient descent. The spectral learning core 1090 updates the global geometric structure of the cognitive manifold, and therefore all future inference and reasoning will operate on this updated structure.

To prevent catastrophic forgetting and ensure stable long-term operation, a spectral plasticity controller 1095 enforces bounded modifications of the spectral basis. Plasticity controller 1095 computes principal angles between the new spectral basis and the previous basis, and verifies that maximum angle or rotation are either rejected, staged across multiple learning cycles, or deferred to maintenance phases where larger modifications are permitted. Similarly, plasticity controller 1095 enforces bounds on eigenvalue drift with tighter bounds applied to low-index eigenvectors that encode global, foundational structure, and looser bounds applied to higher-index eigenvectors that encode local, fine-grained distinctions. This differential treatment implements a form of spectral aging, where low-frequency modes that represent long-term, stable abstractions evolve slowly and persist across long operational horizons, while higher-frequency modes that encode recent or contextual information exhibit faster turnover. Plasticity controller 1095 thereby protects foundational memory structure from disruption while allowing the system to adapt to novel experiences. When proposed updates violate plasticity bounds, controller 1095 may scale back the magnitude of change, trigger deferred learning mechanisms that accumulate evidence before updating, or route the update to a temporal dynamics controller 1004 for scheduling during maintenance phases. These mechanisms collectively ensure that spectral learning reflects persistent structure rather than momentary fluctuations, and that prior experience remains encoded in the persistent spectral basis even as new learning occurs.

Following spectral update, an eigenspace alignment module 1097 ensures that existing manifold coordinates remain consistent with the new spectral basis. When spectral learning updates the basis all existing reasoning trajectories, stored coordinates, and geometric relationships must be transformed into the new coordinate system to maintain continuity. The eigenspace alignment module 1097 computes a rotation or alignment operator R that maps the old spectral frame to the new frame, such that the old and new spectral bases evaluated on the landmark set. This alignment can be computed through orthogonal Procrustes analysis, solving for R where O(m) denotes the group m orthogonal matrices and the Frobenius norm. Once R is computed, alignment module 1097 transforms all stored manifold coordinates, ensuring that reasoning trajectories and neighborhood relationships remain continuous across the learning event. This transformation ensures that reasoning is not reset or invalidated by learning, but smoothly transported into the updated geometry. The aligned coordinates preserve the semantic meaning of points on the manifold while adapting to the refined geometric structure. The eigenspace alignment module 1097 broadcasts the rotation matrix R to all components that maintain manifold coordinates, including manifold store 1002 and downstream reasoning systems.

The learning path culminates in a spectral memory update component 1099, which broadcasts the newly computed spectral basis, updated eigenvalues, and alignment information to all relevant system components. The broadcast may comprise the eigenvector matrix, eigenvalue vector, rotation matrices for coordinate transformation, spectral gap statistics, and timestamp information for consistency management. This broadcast ensures that all system components operate with a consistent, synchronized view of spectral memory, preventing discrepancies that could degrade projection quality or reasoning coherence. Spectral memory update 1099 writes the new spectral basis to the spectral memory store 1007, which serves as the authoritative persistent repository of the system's long-term memory structure. Following broadcast, the system returns to normal inference operation on the updated spectral basis, with all future inference and reasoning benefiting from the structural refinement achieved through learning.

The spectral memory store 1007 can be configured to maintain persistent storage of the complete spectral decomposition, including all retained eigenvectors, corresponding eigenvalues, spectral gap statistics, and historical spectral bases for warm-starting and stability analysis. In some aspects, spectral memory store 1007 can be configured as a long-term memory of the persistent cognitive machine. The eigenvectors define the coordinate axes of the cognitive manifold and therefore determine which directions correspond to smooth, globally coherent variations versus localized or brittle distinctions. The eigenvalues govern the stiffness or resistance associated with motion along each axis, thereby constraining which reasoning trajectories are easy, costly, or effectively forbidden. The spectral gaps indicate the natural dimensional boundaries in the accumulated experience and govern capacity allocation across abstraction levels. Because all local manifold coordinates, neighborhood relationships, geodesics, and reasoning trajectories are functions of this spectral basis, spectral memory store 1007 provides a lossless global encoding of long-term cognitive state, subject only to deliberate truncation or dimensionality control. Spectral memory store 1007 may be implemented with high-bandwidth memory optimized for rapid access during both inference and learning operations. The store supports atomic read and write operations to ensure consistency across concurrent access, and maintains version control to enable rollback if learning updates prove problematic. The spectral memory store 1007 further provides persistence across system restarts, enabling the persistent cognitive machine to restore its complete memory structure by loading the spectral basis and landmark set, immediately resuming operation without retraining.

Supporting the core spectral memory, several auxiliary storage components maintain related data structures. A landmark store 1001 can persist coordinates, modality source information, utilization statistics tracking how often each landmark is queried during harmonic extension, and temporal metadata indicating when each landmark was promoted and last accessed. In some embodiments, landmark store 1001 can be organized to support efficient nearest neighbor queries, typically (but not necessarily) through hierarchical navigable small world (HNSW) graphs, inverted file (IVF) indices, or other approximate nearest neighbor data structures built separately for each modality's semantic metric. These index structures enable logarithmic-time or constant-time identification of the L nearest landmarks for any query point, which is essential for the streaming performance of harmonic extension. The landmark store 1001 is updated by landmark manager 1080 during learning operations, with updates affecting both the stored landmarks and the associated index structures.

A manifold store 1002 holds the coordinates of all active points on the cognitive manifold M, including the m-dimensional coordinate vectors comprising extension residuals and convergence information from compression flow. The manifold store 1002 is organized for efficient neighborhood queries required during compression flow refinement and geometric reasoning operations. For example, the manifold store 1002 incorporates nearest neighbor index structures such as k-d trees, ball trees, or HNSW graphs built on the manifold coordinates themselves, enabling constant-time or logarithmic-time identification of local neighborhoods for any point on the manifold. These indices are incrementally maintained as new points are projected, with updates affecting only local graph or tree structures rather than requiring global reorganization. When eigenspace alignment occurs following spectral learning, the manifold store 1002 receives the rotation matrix R from alignment module 1097 and applies the transformation to all stored coordinates, ensuring consistency with the updated spectral basis.

A modality reliability tracker 1003 maintains weights for each input modality m and computes reliability scores based on projection quality indicators. The reliability scores assess how well each modality is currently being represented by the projection infrastructure, incorporating metrics such as, for example, average residuals indicating coverage quality, consistency of paired projections measuring cross-modal agreement for multimodal inputs, temporal stability of projections from the same modality, and concentration of interpolation weights suggesting landmark adequacy. The weights control the relative influence of each modality in constructing the fused spectral representation, entering into a composite kernel formula used by spectral learning core 1090. In some aspects, modality reliability tracker 1003 implements adaptive weight updates according to bounded adaptation rules where a monotonic mapping from reliability to influence and controls adaptation rate. This mechanism allows the system to gracefully handle scenarios where one or more modalities become temporarily unreliable due to sensor degradation, distribution shift, or novelty, reducing their influence on learning while preserving inference continuity. The weights may be normalized to sum to unity, ensuring that the fusion remains a proper convex combination. The modality reliability tracker 1003 provides current weights to spectral learning core 1090 during kernel construction, and reports reliability statistics to geometric invariant monitor 1070 for detection of modality-specific drift.

A temporal dynamics controller 1004 structures learning across time by distinguishing between continuous adaptation and episodic consolidation, implementing deferred learning mechanisms, and managing spectral aging. During normal operation, temporal dynamics controller 1004 enforces conservative learning thresholds and small plasticity bounds, permitting only minor spectral adjustments for a small tolerance. This continuous adaptation regime allows the system to track slow semantic drift while preserving near-isometry of the cognitive manifold. In contrast, during designated maintenance phases or reduced-interaction states analogous to sleep in biological systems, temporal dynamics controller 1004 relaxes plasticity bounds and permits larger spectral updates, enabling substantial reorganization of memory structure without affecting real-time responsiveness. The controller 1004 implements deferred learning by accumulating evidence of structural novelty over time rather than immediately updating the spectrum upon first detection, ensuring that transient noise or short-lived anomalies do not induce unnecessary global change. Temporal dynamics controller 1004 further implements temporal credit assignment by applying decay factors to landmark participation statistics, so that learning influence grows with persistence and durable structure exerts stronger effects than ephemeral experiences. Controller 1004 manages spectral aging by applying differential plasticity constraints across frequency bands, with tight bounds protecting low-frequency modes that encode foundational abstractions and looser bounds permitting faster turnover of high-frequency modes that encode recent contextual information. These temporal mechanisms collectively enable the system to maintain stable cognition under unbounded experience without requiring wholesale retraining or suffering from destructive interference between learning events.

A federated spectral interface 1005 enables spectral learning across multiple distributed persistent cognitive machines without requiring centralized control or raw data exchange. In federated settings, multiple cognitive machines may operate on disjoint or partially overlapping data streams, with each machine maintaining its own landmark set and spectral basis. Federated spectral interface 1005 facilitates exchange of spectral summaries, which are compact, low-rank representations of spectral memory that do not reveal individual data points. Periodically or upon request, a cognitive machine may transmit selected eigenvalues, eigenvectors evaluated on anchor landmarks, spectral gap statistics, and geometric invariants to peer machines through federated interface 1005. Because the spectrum encodes global structure rather than local instances, these summaries are inherently privacy-preserving while still conveying essential semantic organization. To integrate spectral summaries from multiple machines, federated spectral interface 1005 performs eigenspace alignment using shared or negotiated anchor landmarks. Let A and B denote spectral bases from two machines evaluated on a common anchor set; the interface 1005 computes an alignment operator R by solving a minimization function, where the minimization is over the group of orthogonal matrices. This alignment ensures that spectral memory from different machines can be compared, merged, or jointly reasoned over without forcing identical internal representations. Federated spectral interface 1005 enables collective learning scenarios where detection of novel spectral modes in a peer machine may trigger landmark promotion or capacity expansion locally, while stable low-frequency modes shared across machines may reinforce global abstractions. The interface 1005 further supports distributed geometric reasoning, where reasoning trajectories computed on one machine may be transported via aligned spectral bases to another machine, enabling multi-agent coordination without centralized control. All federated operations respect the autonomy of individual machines, which retain control over their own learning processes while benefiting from collective structure.

The spectral learning system 1000 produces output to the persistent cognitive machine through an output interface 1006, which makes manifold coordinates and spectral structures available to downstream cognitive components. The output interface 1006 provides access to the current manifold coordinates for all projected points, enabling similarity computations, nearest neighbor queries, and clustering operations in the unified semantic space. The interface 1006 further provides access to the spectral basis itself, enabling downstream components to perform spectral projections, mode-specific filtering for abstraction, or trajectory planning in the spectral domain. As spectral learning updates the memory structure over time, output interface 1006 ensures that reasoning quality improves naturally through the refined geometric substrate, without requiring explicit retraining of reasoning procedures or symbolic knowledge bases. The persistent cognitive machine thereby benefits from continuous geometric improvement as experience accumulates, with learning effects manifesting as smoother geodesics, more meaningful distances, better-conditioned local charts, and more reliable analogical mappings.

The architecture illustrated in FIG. 10 embodies several design principles that distinguish spectral learning from conventional learning paradigms. First, the strict separation between inference operations on the left path and learning operations on the right path ensures that day-to-day cognitive activity proceeds on a stable substrate while learning modifies that substrate in a controlled, deliberate manner. This separation enables streaming operation with bounded complexity while preserving the ability to adapt to structural novelty. Second, the identification of the spectral memory store 1007 as the persistent, authoritative encoding of long-term memory rather than as a computational artifact ensures that learning directly updates the system's knowledge base in a mathematically explicit form. Unlike opaque parameter updates in neural systems, spectral learning produces interpretable changes that can be inspected, compared over time, and correlated with promoted landmarks or detected novelty. Third, the use of geometric invariants as learning signals rather than loss gradients provides objective, mathematically principled criteria for detecting when learning is necessary and what type of learning should occur. This eliminates the heuristic, ad hoc threshold selection that plagues conventional systems under nonstationarity. Fourth, the warm-started eigensolver approach with bounded plasticity constraints ensures that spectral learning is continuous and incremental rather than catastrophic, preserving foundational structure while accommodating novelty. Fifth, the landmark-based localization of learning influence provides geometric credit assignment that is explicit and attributable, enabling the system to determine which experiences affect which portions of memory. Sixth, the multimodal fusion through reliability-weighted kernels and federated operation through spectral summary exchange enable scalable learning across heterogeneous inputs and distributed systems without requiring homogenization or centralization.

By implementing learning as controlled spectral evolution rather than parameter optimization, the spectral learning system 1000 enables capabilities that are difficult or impossible in conventional architectures, including stable long-horizon learning without retraining, intrinsic resistance to catastrophic forgetting through spectral gap protection, logarithmic computational scaling as experience accumulates, natural integration of multimodal inputs through composite kernels, privacy-preserving federated learning through spectral summary exchange, and interpretable learning dynamics through explicit geometric invariants. These properties make spectral learning system 1000 particularly well-suited for persistent cognitive machines and other systems requiring durable, adaptive intelligence over extended time horizons.

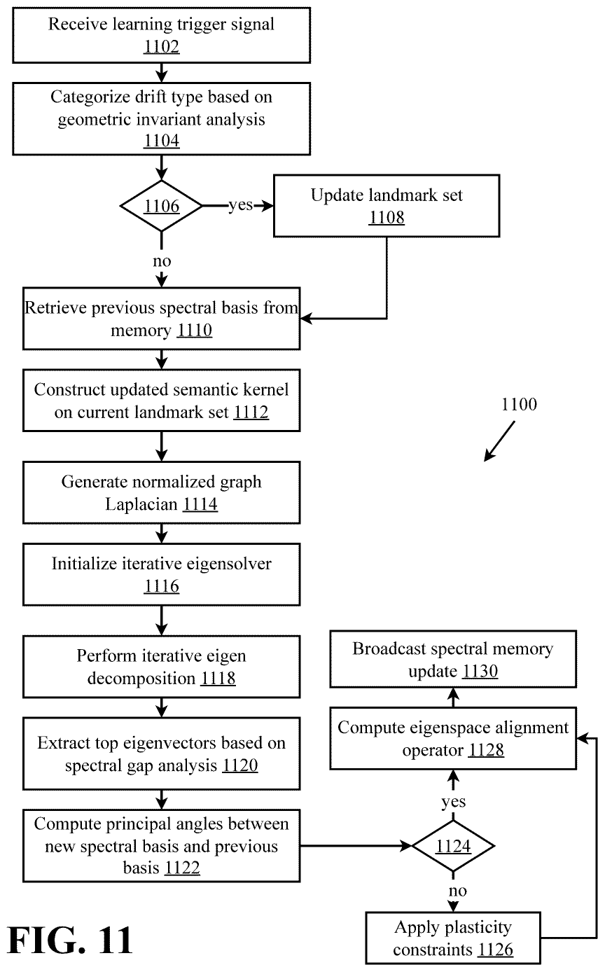

FIG. 11 is a flow diagram illustrating an exemplary method for spectral learning event execution within an adaptive spectral learning system, according to an embodiment. The method 1100 represents the core learning process by which a persistent cognitive machine modifies its spectral memory in response to detected geometric invariant violations, thereby implementing learning as controlled evolution of the spectral decomposition rather than as parameter optimization. Unlike conventional learning methods that update weights through gradient descent, the disclosed method modifies the eigenvalues and eigenvectors of the cognitive manifold's graph Laplacian, thereby updating the global geometric structure that governs all future inference and reasoning operations. The method 1100 embodies the fundamental principle disclosed herein that spectral memory is not merely a computational artifact but is the long-term memory itself, and that learning consists of bounded, invariant-governed modifications to this spectral structure.

According to the embodiment, the process begins at step 1100 when a spectral learning event is initiated. The initiation of this method distinguishes learning operations from inference operations, which proceed on a fixed spectral basis without modification. The spectral learning event represents a deliberate, controlled modification of the system's memory structure triggered by objective geometric signals rather than heuristic loss functions or training schedules. The method 1100 operates concurrently with ongoing inference operations when possible, or during designated maintenance phases when larger spectral modifications are required, ensuring that the persistent cognitive machine can continue serving cognitive demands while adapting its memory structure.

In a step 1102, the system receives a learning trigger signal from the geometric invariant monitor indicating that spectral update is required. This trigger signal represents the culmination of continuous monitoring of geometric invariants during inference operations, where metrics such as principal angles, spectral gap ratios, curvature statistics, injectivity radius estimates, and projection residuals are tracked against predetermined thresholds. The learning trigger is not issued upon every invariant fluctuation, but only when monitored metrics exhibit sustained violations or patterns indicating structural inadequacy of the current spectral basis. The trigger signal carries information about which invariants exceeded thresholds, the magnitude and persistence of violations, and temporal patterns of degradation. This information enables the subsequent categorization of drift type and routing to appropriate learning responses. The receipt of the learning trigger represents a transition point where the system shifts from pure inference operation to active memory modification, implementing the strict architectural separation between using memory and creating or modifying memory.

In a step 1104, the system categorizes the drift type based on which geometric invariants exceeded thresholds. This categorization step implements intelligent routing of learning operations to address specific failure modes rather than applying generic updates regardless of underlying cause. The categorization process examines patterns across multiple indicators to distinguish between different drift scenarios. Large principal angles between successive spectral bases indicate spectral rotation, where the landmark geometry has shifted significantly and the current eigenvectors no longer optimally capture the data structure. High projection residuals concentrated in specific regions indicate coverage gaps, where the landmark set fails to adequately represent novel areas of the latent space. Collapsed spectral gaps indicate capacity saturation, where the current dimensionality m is insufficient to separate signal from noise. Elevated curvature statistics or reduced injectivity radius estimates indicate geometric distortion, where local manifold quality has degraded. Inconsistency across modalities indicates modality drift, where one or more input sources have experienced distribution shift. The categorization considers not only which metrics exceeded thresholds but also their relative magnitudes, temporal ordering, and correlation patterns to identify primary versus secondary causes. This intelligent categorization ensures that learning responses are targeted and appropriate, with different drift types potentially triggering different combinations of landmark updates, spectral refresh, or parameter adjustments.

At decision point 1106, the system evaluates whether coverage degradation has been detected as the primary or contributing drift type. Coverage degradation is identified when projection residuals from harmonic extension operations exceed coverage thresholds in a persistent or spatially clustered manner, indicating that the current landmark set fails to adequately represent one or more regions of the latent space. The decision considers both the absolute magnitude of residuals in identified regions and their impact on overall projection quality, including the number of recent projections affected, the persistence of high residuals over multiple monitoring windows, and the spatial coherence of high-residual points suggesting systematic gaps rather than isolated outliers. If coverage degradation is confirmed, the method branches to landmark management operations; otherwise, it proceeds directly to spectral computation using the existing landmark set. This branching structure reflects the principle that landmark modifications are required only when the substrate for spectral computation is inadequate, while many learning events can proceed through spectral refresh alone.

In a step 1108, when coverage degradation is confirmed, the system updates the landmark set L through promotion of new landmarks and potential removal of underutilized landmarks. The landmark update process implements geometric credit assignment by determining which experiences will directly influence spectral evolution. The promotion procedure begins by identifying high-residual regions through spatial analysis of accumulated residual statistics, using techniques such as spatial hashing or clustering algorithms to group residuals by location in the latent space. Within these high-residual regions, candidate points are selected based on multiple criteria including centrality within the region to maximize coverage improvement, stability over time to avoid selecting transient outliers, diversity relative to existing landmarks to avoid redundancy, and representativeness of the local data distribution. The evaluation computes pairwise distances between candidates and existing landmarks in the semantic metric, estimates the coverage improvement each candidate would provide using leave-one-out prediction approaches, and assesses stability by examining neighborhood consistency over time. Candidates that are too similar to existing landmarks or to each other are filtered out, while those providing maximal coverage improvement with minimal redundancy are retained for promotion. The promotion process adds selected candidates to the active landmark set, expanding L to L′. Simultaneously, the system may identify underutilized landmarks based on utilization statistics tracked during inference, including how often each landmark appears among nearest neighbors during harmonic extension, with what average weight it contributes to interpolations, and whether its removal would significantly impact projection quality. Landmarks showing consistently low utilization while maintaining adequate coverage are candidates for removal, helping to maintain a compact and efficient landmark set. The removal process is conservative, verifying that neighboring landmarks can adequately cover the removed landmark's region and that no recent high-residual points would be affected. The number of promotions and removals in each learning event is bounded to prevent sudden expansions or contractions that could destabilize the spectral basis, typically promoting between one and five percent of new landmarks when coverage gaps are detected. Following landmark update, the method has modified the substrate L upon which spectral decomposition will be computed, defining which experiences can directly influence the spectral basis.

Following the decision point 1106, whether landmark update occurred or not, the method converges to a step 1110 where the system retrieves the previous spectral basis Φ^{(O)} from the spectral memory store for warm-starting the iterative eigensolver. The warm-start procedure is critical for enabling efficient spectral learning, as it provides excellent initial conditions that dramatically reduce the number of iterations required for convergence. The previous spectral basis comprises the eigenvectors {φₖ} computed during the last spectral learning event, stored in the spectral memory store along with their corresponding eigenvalues {λₖ} and metadata. If the landmark set has been modified from L to L′, the retrieval process extends the previous eigenvectors to the new landmark set dimensionality, typically by zero-padding or nearest-neighbor interpolation for newly added landmarks, and by deletion of rows corresponding to removed landmarks. The extended eigenvectors are then orthonormalized to provide proper initial iterates for the eigensolver. Because landmark changes are typically small relative to the total landmark set size—with only a few percent of landmarks added or removed in each learning event—the extended and orthonormalized eigenvectors remain close to the true eigenvectors of the updated system, ensuring rapid convergence. The warm-start mechanism embodies the principle of continuous, incremental learning rather than wholesale recomputation, enabling spectral learning to proceed with bounded computational cost even as the system accumulates unbounded experience. The retrieval of previous spectral basis also serves a stability function, ensuring that learning builds upon established structure rather than starting from random initialization that could produce arbitrary rotations of the spectral coordinate system.

In a step 1112, the system constructs an updated semantic kernel K on the current landmark set using the formula K(lᵢ, lⱼ)=exp(−Σₘαₘdₘ(lᵢ, lⱼ)), where the sum is over all modalities m with corresponding semantic distance functions dₘ and current modality weights αₘ. The kernel construction implements the multimodal fusion aspect of spectral learning, allowing heterogeneous input sources to contribute to a unified spectral representation through modality-specific semantic metrics weighted by their current reliability. For each pair of landmarks (lᵢ, lⱼ) , the system evaluates the semantic distance dₘ(lᵢ, lⱼ) in each modality m from which the landmarks originate or to which they are relevant. The semantic distance for a visual modality may emphasize perceptual similarity based on learned features or handcrafted descriptors; for a language modality, the distance may incorporate syntactic structure, semantic relatedness, or contextual embeddings; for a temporal modality, the distance may weight recent proximity more heavily than distant relationships. The modality weights αₘ are retrieved from the modality reliability tracker, reflecting current reliability estimates based on projection quality, cross-modal consistency, and temporal stability. Modalities experiencing distribution drift, sensor degradation, or poor landmark coverage receive lower weights, reducing their influence on the spectral structure. The weighted distances across all modalities are summed and exponentiated to produce the kernel value K(lᵢ, lⱼ) , which quantifies the affinity or connection strength between landmarks. High kernel values indicate strong semantic relationship; low values indicate weak or no relationship. The kernel matrix K is typically sparse, as most landmark pairs have negligible affinity, and may be further sparsified by thresholding small values to reduce computational costs. The kernel construction may leverage incremental computation when the landmark set has changed minimally, computing kernel entries only for pairs involving newly added landmarks while reusing entries for unchanged landmark pairs. The resulting kernel K encodes the current semantic structure of accumulated experience as understood through all available modalities, weighted by their reliability, and serves as the foundation for spectral decomposition.

In a step 1114, the system generates a normalized graph Laplacian L from the updated kernel using the formula L=I−D^{-1/2}KD^{-1/2}, where D is the diagonal degree matrix with entries Dᵢⱼ=ΣⱼK(lᵢ, lⱼ) . The normalization procedure transforms the raw affinity kernel into a diffusion operator whose spectral decomposition reveals the intrinsic geometric structure of the data. The degree matrix D captures the total connectivity or centrality of each landmark, with highly connected landmarks having large degree values. The inverse square root normalization D^{-1/2} ensures that the resulting Laplacian has eigenvalues in the range [0, 2], with 0 corresponding to the constant eigenvector and larger eigenvalues corresponding to increasingly rapid oscillations across the graph. The normalized Laplacian has several advantageous properties: it is symmetric positive semi-definite, ensuring real non-negative eigenvalues and orthogonal eigenvectors; its eigenvalues are bounded, providing numerical stability; and its spectral decomposition corresponds to a natural coordinate system based on diffusion geometry, where coordinates along low eigenvalue eigenvectors vary smoothly across the graph while coordinates along high eigenvalue eigenvectors encode local or high-frequency structure. The Laplacian construction may also employ incremental updates when landmark changes are minimal, modifying only rows and columns corresponding to changed landmarks rather than recomputing the entire matrix. The resulting Laplacian L encodes the geometry of semantic relationships among landmarks and serves as the operator whose spectral decomposition will define the cognitive manifold's coordinate system.

In a step 1116, the system initializes an iterative eigensolver using the previous eigenvectors Φ^{(O)} as warm-start initial conditions, enabling rapid convergence. The iterative eigensolver may be a Lanczos method, which is particularly effective for symmetric matrices and can compute the smallest or largest eigenvalues and their corresponding eigenvectors through a Krylov subspace iteration, or a locally optimal block preconditioned conjugate gradient (LOBPCG) method, which can compute multiple eigenpairs simultaneously and benefits strongly from good initial conditions. The warm-start initialization projects the previous eigenvectors Φ^{(O)} onto the space of the updated Laplacian, accounting for any dimensionality changes due to landmark additions or removals, and orthonormalizes them using Gram-Schmidt or QR decomposition to provide valid initial iterates. Because landmark changes are typically small, the projected and orthonormalized previous eigenvectors are usually excellent approximations to the true eigenvectors of the updated Laplacian, lying close to the sought eigenvectors in the high-dimensional space. This proximity dramatically reduces the number of iterations required for convergence, often by an order of magnitude compared to random or identity initialization. The warm-start approach embodies the principle of continuous learning, where each spectral update builds incrementally on previous structure rather than starting anew, ensuring that low-frequency modes encoding foundational structure remain stable while higher-frequency modes adapt to accommodate novelty. The eigensolver initialization also sets convergence tolerances based on the spectral gap and desired precision, with tighter tolerances for low-frequency modes that will be retained and looser tolerances for high-frequency modes that may be truncated. Monitoring mechanisms are established to track residual norms, eigenvalue stability, and iteration count, enabling early termination when convergence is achieved or adaptive parameter adjustment if convergence proves difficult.

In a step 1118, the system performs iterative eigen decomposition by solving Lφ′ₖ=λ′_{kφ′k} for k=1, . . . , r, where r is the number of eigenpairs to compute, typically larger than the final retained dimensionality m to enable spectral gap analysis. This step represents the core of the spectral learning process, as it computes the new eigenvalues {λ′ₖ} and eigenvectors {φ′ₖ} that will replace the previous spectral basis and thereby update the system's long-term memory. The iterative solver proceeds through successive refinements of the eigenvector estimates, leveraging the warm-start initialization to begin close to the solution. At each iteration, the solver applies the Laplacian operator to current eigenvector estimates, computes residuals to assess convergence, and updates estimates to reduce residuals while maintaining orthogonality. The Lanczos or LOBPCG algorithm constructs a sequence of increasingly accurate approximations to the true eigenvectors, with convergence typically occurring when residual norms fall below specified tolerances or when relative changes in eigenvalues between iterations become negligible. Throughout the iteration, the solver maintains numerical stability through periodic reorthogonalization of eigenvectors, ensuring that they remain orthogonal despite accumulation of floating-point errors. The solver monitors convergence through multiple criteria including absolute residual tolerance based on Laplacian application residuals, relative eigenvalue tolerance based on fractional changes in eigenvalues, and spectral gap stability indicating that the eigenvalue ordering has stabilized. The warm-start initialization typically enables convergence within tens to hundreds of iterations even for landmark sets containing thousands of points, maintaining bounded computational cost. This step is explicitly labeled as “THIS IS LEARNING” because it is here that the spectral basis is modified—the computation of new {φ′ₖ} and {λ′ₖ} constitutes the update to spectral memory and therefore represents learning in the disclosed system. Unlike parameter-based learning where gradient descent modifies weights, or token-based learning where new memories are stored as discrete artifacts, spectral learning modifies the global geometric structure that governs semantic relationships, neighborhood definitions, geodesic paths, and reasoning trajectories. Upon convergence, the eigenvector matrix Φ′ contains the new spectral coordinates for all landmarks, and the eigenvalue vector λ′ characterizes the geometric properties of each spectral mode.

In a step 1120, the system extracts the top m eigenvectors based on spectral gap analysis by identifying the largest gap in the eigenvalue sequence {λ′ₖ}. The spectral gap analysis implements principled dimensionality selection rather than relying on arbitrary threshold parameters. The eigenvalues are ordered as 0=λ′₁≤λ′₂≤ . . . ≤λ′ᵣ, with the first eigenvalue always zero corresponding to the constant eigenvector, which is typically discarded. The gaps between consecutive eigenvalues are computed as gₖ=λ′ₖ₊_{₁}−λ′ₖ for k=2, . . . , r−1, and the index m is selected where the gap gₘ is maximal or where the ratio gₘ/gₘ₋_{₁} exceeds a significance threshold. A large spectral gap indicates a natural dimensional boundary in the data structure, separating eigenvalues associated with signal from eigenvalues associated with noise or fine-grained variations. The retained eigenvectors {φ′₁, . . . , φ′ₘ} define the spectral basis that will be used for all future harmonic extension and geometric reasoning operations, while eigenvectors {φ′ₘ₊_{₁}, . . . , φ′ᵣ} corresponding to eigenvalues above the gap are discarded as encoding primarily noise or overly specific structure that does not generalize. The selection of m may vary across learning events as the accumulated experience evolves, with m increasing when new structure emerges that cannot be captured in the existing dimensionality, or decreasing when previously distinct modes merge or become redundant. The spectral gap analysis provides an objective, data-driven criterion for capacity allocation, ensuring that the manifold dimensionality adapts to the intrinsic complexity of accumulated experience rather than being fixed by hyperparameter choice. The selected eigenvectors form the columns of the new spectral basis matrix Φ′∈R^{n×m}, where n=|L′| is the current landmark count, and this matrix defines the spectral coordinates for all landmarks and, through harmonic extension, for all future projected points.

In a step 1122, the system computes principal angles θᵢ between the new spectral basis {φ′ₖ} and the previous basis {φₖ}, and computes eigenvalue drift |λ′ₖ−λₖ| for each retained mode. These computations quantify how much the spectral memory has changed during the learning event and provide the basis for enforcing plasticity constraints that prevent catastrophic forgetting. The principal angles are computed through singular value decomposition of the inner product matrix between the two bases: the matrices Φ and Φ′ are formed from the previous and new eigenvectors respectively, both restricted to the common landmark set if the landmark count has changed, and the matrix product (Φ′)^{T}Φ is computed. This m×m matrix captures the overlap between corresponding eigenvectors in the two bases. Singular value decomposition (Φ′)^{T}Φ=UΣV^{T} yields singular values σᵢ, and the principal angles are defined as θᵢ=arccos(σᵢ). Small principal angles (near zero degrees) indicate that the new basis is a minor rotation of the previous basis, suggesting incremental refinement of spectral memory. Large principal angles (approaching ninety degrees) indicate substantial rotation, suggesting that the landmark geometry has changed significantly and the spectral coordinates have undergone major reorganization. The distribution of principal angles across modes provides insight into which spectral directions have remained stable versus which have rotated substantially. Simultaneously, the eigenvalue drift is computed for each mode k as Δλₖ=|λ′ₖ−λₖ|, quantifying how much the geometric stiffness or resistance associated with each spectral direction has changed. Large eigenvalue drift indicates changes in the relative importance or coherence of different spectral modes. Together, principal angles and eigenvalue drift provide comprehensive characterization of spectral change, enabling informed decisions about whether the update should be accepted, scaled, or deferred.

At decision point 1124, the system evaluates whether the plasticity bounds are satisfied by comparing the computed principal angles and eigenvalue drifts against predetermined thresholds. The plasticity bounds implement stability constraints that prevent catastrophic forgetting by limiting how much spectral memory can change in a single learning event. The evaluation checks multiple conditions: whether the maximum principal angle satisfies max θᵢ≤θₘ_{ₐₓ}, where θₘ_{ₐₓ} is a stability threshold typically set between five and fifteen degrees to balance adaptability with continuity; whether eigenvalue drifts satisfy |λ′ₖ−λₖ|≤εₖ for each mode k, where the bounds εₖ are mode-dependent with tighter bounds applied to low-index eigenvectors encoding global structure and looser bounds permitted for high-index eigenvectors encoding local detail; and whether the overall spectral change satisfies global criteria such as Frobenius norm bounds on the difference ∥Φ′−Φ∥F. The plasticity bounds may be adaptive, tightening when the system is operating in familiar, well-understood regions and relaxing when exploring novel areas or during designated consolidation phases. The bounds implement differential protection across frequency bands, ensuring that low-frequency modes representing foundational, long-term abstractions evolve slowly and remain stable across learning events, while higher-frequency modes representing recent or contextual information may exhibit faster turnover. If all plasticity bounds are satisfied, the spectral update is accepted immediately and the method proceeds to eigenspace alignment. If any bound is violated, the method branches to apply plasticity constraints that scale, defer, or reject the proposed update.

In a step 1126, when plasticity bounds are not satisfied, the system applies plasticity constraints to bring the spectral update within acceptable limits or to defer it to a more appropriate time. The plasticity constraint application implements several strategies depending on the nature and magnitude of violations. For moderate violations where principal angles exceed θₘ_{ₐₓ} by a small margin, the system may apply a scaling factor to the spectral rotation, computing an intermediate basis Φ″ that represents a partial rotation from Φ toward Φ′, such that the principal angles to Φ are exactly at the threshold θₘ_{ₐₓ}. This scaled update allows partial incorporation of the structural change while maintaining stability constraints. For violations involving low-frequency modes where eigenvalue drift exceeds tight bounds, the system may selectively accept updates to higher-frequency modes while retaining previous low-frequency modes unchanged, protecting foundational structure while allowing adaptation in detailed structure. For severe violations indicating major structural disruption, the system may defer the entire spectral update to a maintenance phase or consolidation event where larger changes are permitted, accumulating the evidence for change but declining to immediately update spectral memory. The deferral mechanism implements temporal credit assignment, ensuring that learning reflects persistent structure rather than momentary fluctuations. The constraint application also considers the drift type categorized in step 1104, with different strategies applied for spectral rotation versus capacity saturation versus geometric distortion. Throughout the constraint application, the system logs the nature of violations, the scaling or deferral decisions made, and the rationale, providing transparency and supporting offline analysis of learning dynamics. After applying constraints, the system either proceeds with a bounded spectral update or returns to normal operation with the previous spectral basis retained, having recorded the evidence for future consolidation. In either case, the plasticity constraints ensure that spectral learning proceeds gradually and continuously rather than through disruptive jumps that could destroy previously learned structure.

Following satisfaction of plasticity bounds, either directly from decision point 1124 or after constraint application in step 1126, the method proceeds to a step 1128 where the system computes an eigenspace alignment operator R that maps old coordinates to new. The eigenspace alignment is essential for maintaining continuity of reasoning and stored manifold coordinates across the spectral update. When the spectral basis changes from {φₖ} to {φ′ₖ}, all existing manifold coordinates Ψ(x) that were computed using the old basis must be transformed to remain consistent with the new basis, otherwise reasoning trajectories would be disrupted, stored similarities would become meaningless, and the cognitive state would be effectively reset. The alignment operator R is computed through orthogonal Procrustes analysis, which finds the optimal orthogonal rotation that aligns the new basis with the old basis. Formally, the problem is stated as R=argmin Q∈O(m) ∥Φ′−ΦQ∥F, where O(m) denotes the group of m×m orthogonal matrices preserving lengths and angles, and ∥·∥F denotes the Frobenius norm measuring matrix difference. The Procrustes solution is obtained by computing the singular value decomposition of the cross-covariance matrix Φ^{T}Φ′=UΣV^{T}, and setting R=VU^{T}, which is guaranteed to be an orthogonal matrix that minimizes the alignment error. The resulting rotation R captures how the spectral coordinate system has rotated due to landmark changes and Laplacian evolution. The alignment operator enables transformation of existing coordinates via γ′(t)=Rγ(t), where γ(t) represents a coordinate vector or reasoning trajectory in the old basis and γ′(t) is its representation in the new basis. This transformation ensures that semantic relationships, neighborhood structures, and reasoning paths remain continuous across the learning event—reasoning is not reset but smoothly transported into the updated geometry. The alignment computation may also produce inverse transformations R⁻¹=R^{T} for any operations requiring mapping from new coordinates back to the old frame. The alignment operator is packaged with the spectral update for broadcast to all system components that maintain manifold coordinates.

In a step 1130, the system broadcasts the spectral memory update to all system components, including the new eigenvectors {φ′ₖ}, new eigenvalues {λ′ₖ}, the alignment operator R, and timestamp information for consistency management. This broadcast represents the culmination of the spectral learning event, as it propagates the updated spectral memory throughout the system and enables all future operations to benefit from the refined geometric structure. The broadcast includes the complete eigenvector matrix Φ′∈R^{n×m} evaluated at all current landmarks, providing the spectral coordinates that will be used for harmonic extension of future points. The eigenvalue vector λ′∈R^{m} characterizes the stiffness or importance of each spectral mode, informing operations such as spectral gap monitoring and mode-specific filtering for abstraction. The alignment operator R∈R^{m×m} enables components that maintain stored manifold coordinates to transform them into the new coordinate system. The timestamp τ marks when the spectral update occurred, supporting version control and ensuring that components can detect when they are operating on stale spectral bases. The broadcast targets multiple system components including the spectral memory store, which receives the new basis as the authoritative current spectral memory and archives the previous basis for warm-starting future updates and stability analysis; the landmark store, which may receive updated spectral coordinates for landmarks if the landmark set was modified; the manifold store, which must transform all stored point coordinates using the alignment operator R to maintain consistency; the harmonic extension module, which will use the new spectral coordinates for all future projections; the compression flow engine, which will operate on the updated manifold geometry; the geometric reasoning engine, which will compute trajectories on the refined manifold; and the geometric invariant monitor, which resets its drift tracking baselines to the new spectral reference. The broadcast may be implemented through message passing in distributed systems, through shared memory updates in monolithic systems, or through database transactions in persistent storage systems. The broadcast includes mechanisms for acknowledgment and consistency verification, ensuring that all components successfully receive and apply the update before the system resumes normal operation. Following successful broadcast, the spectral memory has been updated system-wide, and all future inference and reasoning will operate on the new geometric structure.

Upon completion of the broadcast, the method reaches an end state at step 1132, having successfully completed the spectral learning event. The completion of this method represents a fundamental update to the system's long-term memory—the cognitive manifold now has a new geometric structure defined by the updated spectral basis, and this structure will govern all subsequent cognitive operations until the next learning event. The completion does not mean that the system stops or resets; rather, the system seamlessly returns to normal inference operation, now benefiting from the improved spectral memory. New input points will be projected using the updated eigenvectors, reasoning will follow trajectories on the refined manifold geometry, and geometric invariant monitoring will begin tracking drift relative to the new spectral reference. The learning event completion is logged with comprehensive metadata including the trigger conditions that initiated learning, the drift type categorized, whether landmark updates occurred and their extent, the number of eigensolver iterations required, the principal angles and eigenvalue drifts achieved, whether plasticity constraints were applied, the computational cost and wall-clock time, and quality metrics for the resulting spectral basis. This logging supports offline analysis of learning dynamics, tuning of plasticity bounds and convergence parameters, and verification that learning is achieving its intended effects of maintaining projection quality and geometric coherence over long time horizons.

The method 1100 embodies several design principles that distinguish spectral learning from conventional learning paradigms. First, the method explicitly separates the learning operation from inference, with learning triggered by objective geometric signals rather than occurring continuously during every data encounter. This separation enables stable, efficient inference on a fixed substrate while allowing deliberate memory modification when warranted. Second, the method implements learning as modification of spectral decomposition rather than parameter adjustment, updating the global geometric structure rather than local connection weights, and thereby achieving learning that is mathematically explicit, globally coherent, and intrinsically interpretable. Third, the warm-started eigensolver approach enables efficient incremental learning by building on previous spectral structure rather than recomputing from scratch, ensuring that learning complexity remains bounded even as experience accumulates without limit. Fourth, the plasticity bounds enforce gradual, continuous evolution of spectral memory rather than disruptive jumps, protecting foundational low-frequency structure while allowing adaptation in higher-frequency detail, thereby preventing catastrophic forgetting without requiring explicit replay or rehearsal. Fifth, the eigenspace alignment ensures continuity of reasoning across learning events by transforming existing coordinates into the updated basis, preventing the reset or invalidation of prior reasoning that would occur if coordinates were not aligned. Sixth, the method supports both immediate spectral updates when changes are minor and deferred consolidation when changes are substantial, enabling flexible temporal scheduling of learning that balances responsiveness with stability.

By implementing learning as controlled spectral evolution, method 1100 supports capabilities that are difficult or impossible with conventional architectures. The method enables accumulation of unbounded experience into bounded spectral memory through principled dimensionality selection via spectral gaps. The method maintains long-term stability through plasticity bounds that prevent catastrophic forgetting without replay. The method provides interpretability through explicit geometric invariants that quantify what is being learned and how much memory has changed. The method supports multimodal learning through reliability-weighted kernel construction that allows heterogeneous inputs to contribute to unified spectral structure. The method enables federated learning through compact spectral summaries that can be exchanged across sites without sharing raw data. The method improves reasoning quality naturally as spectral structure refines, without requiring explicit retraining of reasoning procedures. These properties make the method particularly well-suited for persistent cognitive machines operating over extended time horizons, where learning must be stable, efficient, interpretable, and compatible with continuous operation. The method demonstrates that learning need not be realized through parameter modification but can instead be embodied in the evolution of geometric structure, with memory encoded in spectra and learning achieved through bounded spectral refinement guided by geometric invariants.

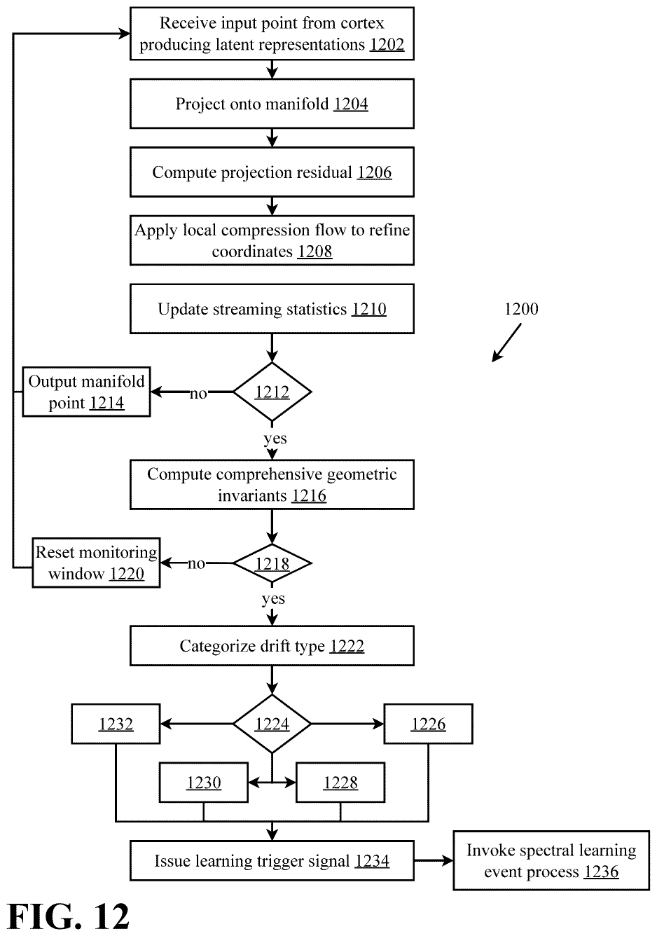

FIG. 12 is a flow diagram illustrating an exemplary method for inference-learning decision within an adaptive spectral learning system, according to an embodiment. The method 1200 represents a continuous operational loop by which a persistent cognitive machine distinguishes between inference operations that use existing spectral memory and learning operations that modify spectral memory, implementing the separation between using memory and creating or modifying memory. According to an embodiment, the method operates primarily in an inference mode where projection and reasoning proceed on a fixed spectral basis, while learning is triggered selectively based on objective geometric signals indicating structural inadequacy. This separation enables stable, efficient cognitive operation with bounded computational complexity while preserving the ability to adapt spectral memory when warranted by measured geometric invariants. The method 1200 embodies the principle that learning should be deliberate, triggered by persistent evidence of structural change rather than transient fluctuations, and targeted to address specific failure modes rather than applying generic updates.

According to the embodiment, the process begins when the system initiates the inference-learning decision cycle. This cycle represents the primary operational mode of the persistent cognitive machine, running continuously as the system processes input streams from multiple cortices. The initiation establishes monitoring state, initializes streaming statistical accumulators, and prepares the system to route inputs through inference operations while concurrently tracking geometric invariants. The cycle operates with dual time scales: a fast inner loop processing individual inputs through inference, and a slower outer loop evaluating accumulated statistics to detect when learning is necessary. This dual-loop structure ensures that the computational cost of individual projections remains bounded while enabling comprehensive monitoring that can detect gradual drift over extended periods.

In a step 1202, the system receives an input point x from cortex j producing a latent representation in high-dimensional space Sj. This input represents new experience arriving from one of the multiple heterogeneous cortical sources that may include visual processors, language models, temporal sequence analyzers, or other specialized cognitive modules. Each cortex generates latent states with distinct dimensional characteristics, distributional properties, and semantic structure reflecting its modality-specific processing. The input arrives with metadata identifying the source cortex j, which determines which modality-specific semantic metric will be applied during subsequent processing, timestamp information for temporal analysis, and potentially confidence measures or attention weights indicating the salience of the input. The reception of this input marks the beginning of an inference operation that will project the new experience onto the existing cognitive manifold without modifying the spectral basis.

In a step 1204, the system projects the input onto the manifold via harmonic extension using the CURRENT spectral basis, computing Ψ(x)=Σwᵢ(x)Φ(lᵢ) where the sum is over the L nearest landmarks identified in the modality-specific semantic metric for cortex j. This projection operation is explicitly labeled as inference because it operates on the fixed spectral basis {φₖ} without any modification of the eigenvectors or eigenvalues that define spectral memory. The harmonic extension process queries the landmark store to identify the L nearest landmarks using the semantic metric djsem appropriate to cortex j, computes attachment weights wᵢ(x)=exp(−κⱼdjsem(x,lᵢ)) normalized to sum to unity, retrieves the spectral coordinates Φ(lᵢ) for each of the L nearest landmarks from the spectral cache, and calculates the weighted barycentric combination Ψ(x) that represents the new point's initial position on the manifold. This computation has bounded complexity independent of the total number of previously projected points, enabling constant-time or logarithmic-time projection as experience accumulates. The harmonic extension provides a principled first approximation that respects the semantic relationships encoded in the current spectral basis while maintaining the global geometric structure of the manifold. This operation accesses spectral memory in read-only mode—the eigenvectors {φₖ} are used but not modified, embodying the distinction between inference and learning.

In a step 1206, the system computes the projection residual r(x)=∥Ψ(x)−Σwᵢ(x)Φ(lᵢ)∥ measuring harmonic extension quality. The residual quantifies how well the new point can be represented by weighted interpolation from existing landmarks, with small residuals indicating that the current landmark set provides adequate coverage and large residuals suggesting that the point lies in a region poorly represented by existing landmarks. The residual computation involves evaluating the norm of the difference between the computed coordinates and the ideal harmonic coordinates, which in the discrete case equals zero by construction but may be non-zero after compression flow refinement or when evaluating out-of-sample extension quality. The residual serves as a primary signal for coverage quality and will be accumulated in streaming statistics to detect systematic coverage degradation. The computation also produces secondary metrics such as the distribution of weights across the L nearest landmarks, with highly concentrated weights indicating reliance on a single landmark suggesting potential landmark promotion nearby, and the distances to the nearest landmarks in both semantic space and manifold space, enabling consistency checks.

In a step 1208, the system applies local compression flow to refine coordinates on the fixed manifold geometry. This refinement operation implements geometric optimization to improve local manifold quality while operating within the constraints imposed by the current spectral basis. The compression flow computes gradients of a geometric energy functional that includes semantic coherence terms encouraging semantically similar points to remain close on the manifold, curvature penalty terms discouraging excessive local curvature, density regularization terms promoting uniform sampling density, and chart conditioning terms ensuring well-behaved local coordinate systems. These gradients are projected onto the local tangent space estimated from neighboring manifold points to ensure updates remain on the manifold, and coordinates are updated through small steps bounded by local geometric constraints. The compression flow operates only on the local neighborhood of the new point, identified through efficient spatial data structures on the manifold coordinates, maintaining bounded computational complexity. This refinement modifies only the manifold coordinates Ψ(x) for the new point and its immediate neighbors—it does not modify the spectral basis {φₖ} that defines the global manifold geometry. The compression flow thus represents inference rather than learning, as it operates within the constraints of existing spectral memory rather than modifying that memory. The flow typically converges within one to three iterations for streaming operation, providing meaningful local optimization without excessive computation.

In a step 1210, the system updates streaming statistics by accumulating the projection residual r(x) to the residual distribution, updating curvature estimates based on local geometric computations, and tracking density metrics characterizing the distribution of points on the manifold. These statistics are maintained using streaming algorithms that update running estimates without storing individual values, including Welford's algorithm for means and variances, P-square algorithm for quantiles, and exponentially weighted moving averages for temporal trends. The statistics may be segmented by modality to detect modality-specific drift, by spatial region using coarse spatial hashing to identify localized problems, and by temporal window using multiple time scales to distinguish transient fluctuations from persistent changes. The residual r(x) can be added to a histogram or kernel density estimator maintaining the distribution of residuals across recent projections. Curvature estimates derived from the compression flow optimization are aggregated into running statistics of mean curvature, variance of curvature, and extreme values. Density metrics track the local neighborhood sizes and distances in the manifold coordinates, enabling detection of overcrowding or sparsification. These streaming statistics provide the raw material for subsequent geometric invariant computation while requiring minimal memory and constant-time updates per projection.

At decision point 1212, the system evaluates whether the monitoring window is complete. The monitoring window represents an accumulation period over which streaming statistics are gathered before comprehensive geometric invariant evaluation. The window may be defined by the number of projected points, typically hundreds to thousands of projections providing sufficient statistical power while maintaining responsiveness, elapsed wall-clock time ensuring regular monitoring even if projection rates vary, or event-based triggers such as completion of a processing batch or explicit monitoring requests. The window size balances statistical reliability requiring sufficient samples against responsiveness to rapid changes, and may be adaptive based on the rate of observed change with shorter windows during periods of instability and longer windows during stable operation. If the monitoring window is not complete, the system continues inference operations without evaluating invariants, maintaining maximum efficiency for the common case where learning is not required. This decision implements the fast inner loop of the dual-loop structure, enabling many projections to be processed with minimal overhead.

In a step 1214, when the monitoring window is incomplete, the system outputs the manifold point Ψ(x) and continues inference operations. The output makes the manifold coordinates available to downstream components of the persistent cognitive machine such as the thought cache for storage, the geometric reasoning engine for trajectory planning, similarity search systems for retrieval, or other cognitive modules requiring unified semantic representations. The output includes not only the m-dimensional coordinate vector but also metadata such as the projection timestamp, source cortex identifier, quality metrics including the projection residual and convergence status, and references to the nearest landmarks for potential reverse mapping or explanation. Following output, the system returns to step 1202 to receive the next input point, creating a tight inference loop that can process inputs at high throughput with bounded latency. This loop represents the primary operational mode of the system, with the vast majority of inputs being processed purely through inference without triggering learning.

When the monitoring window is complete at decision point 1212, the system proceeds to step 1216 where it computes comprehensive geometric invariants including principal angles if the spectral basis has been updated since the last monitoring cycle, spectral gap ratios ρ=(λₘ₊_{₁}−λₘ)/λₘ measuring the separation between retained and discarded eigenvalues, curvature statistics capturing the mean, variance, and extreme values of local curvature across the manifold, and residual quantiles and spatial clustering identifying regions of systematically high residuals. The principal angle computation involves retrieving the current spectral basis {φₖ} and the reference basis from the previous monitoring cycle, computing their inner product matrix, performing singular value decomposition to obtain singular values σᵢ, and calculating angles θᵢ=arccos(σᵢ) that quantify rotation of the spectral coordinate system. The spectral gap computation retrieves the current eigenvalues {λₖ} and evaluates the gap ratio at the truncation boundary m, with small ratios indicating capacity saturation where the current dimensionality is insufficient. Curvature statistics can be computed from the streaming estimates accumulated during step 1210, calculating summary statistics that characterize the distribution of local curvature across all recent projections. Residual analysis involves computing quantile estimates from the accumulated residual distribution, identifying the top percentile of residuals as candidates for coverage issues, clustering high-residual points spatially to identify contiguous regions of poor coverage, and comparing residual distributions across modalities to detect modality-specific problems. These comprehensive invariants provide objective, mathematically principled signals about the health and adequacy of the current spectral memory, enabling informed decisions about whether learning is necessary.

At decision point 1218, the system evaluates whether any invariant threshold has been exceeded. This evaluation compares each computed invariant against predetermined thresholds that indicate when adaptation is necessary, with thresholds set based on theoretical requirements for manifold regularity, empirical stability boundaries observed during development, and adaptive percentiles ensuring that only genuinely anomalous behavior triggers learning. The evaluation checks whether maximum principal angles exceed θₘ_{ₐₓ}, typically (but not limited to) five to fifteen degrees, indicating significant rotation of spectral memory, whether the spectral gap ratio falls below ρₘᵢₙ, typically (but not limited to) 0.1 to 0.5, indicating capacity saturation, whether curvature statistics exceed acceptable bounds indicating geometric distortion, and whether residual quantiles exceed coverage thresholds indicating landmark inadequacy. The thresholds may be adaptive, tightening during stable periods when high confidence in spectral memory is justified and relaxing during exploration of novel semantic territories. The evaluation considers not only individual thresholds but also patterns across multiple invariants, as certain combinations may indicate specific drift scenarios requiring targeted responses. If no threshold is exceeded, indicating that the current spectral memory remains adequate, the system proceeds to reset the monitoring window and continue inference.

In a step 1220, when no invariant thresholds are exceeded, the system resets the monitoring window to begin accumulating fresh statistics for the next monitoring cycle. The reset clears short-term statistical accumulators while preserving long-term trend information, establishes a new reference spectral basis for the next round of principal angle computation if spectral updates occur during the cycle, and adjusts monitoring window parameters if adaptive sizing is employed. Following reset, the system returns to step 1202 to continue processing inputs through inference, having confirmed that learning is not currently warranted. This path represents the stable operational regime where the spectral basis adequately represents accumulated experience and no structural modification is required.

When any invariant threshold is exceeded at decision point 1218, the system proceeds to step 1222 where it categorizes the drift type based on which invariants exceeded thresholds. This categorization implements intelligent routing of learning operations to address specific failure modes rather than applying generic updates. The categorization examines patterns across the suite of computed invariants to distinguish between different drift scenarios. Large principal angles between successive spectral bases indicate spectral rotation, where the landmark geometry has shifted significantly and the current eigenvectors no longer optimally capture the data structure, often caused by gradual distributional drift in the input streams or by major structural changes following landmark updates. High projection residuals concentrated in specific spatial regions indicate coverage gaps, where the landmark set fails to adequately represent novel areas of the latent space, typically arising from exploration of previously unseen semantic territories or from non-stationary input distributions introducing new structure. Collapsed spectral gaps with ratios ρ approaching zero indicate capacity saturation, where the current dimensionality m is insufficient to separate signal from noise, requiring either increased dimensionality or landmark reorganization. Elevated curvature statistics or reduced injectivity radius estimates indicate geometric distortion, where local manifold quality has degraded through accumulation of compression flow approximations or through inconsistent density, potentially requiring parameter adjustments to energy functional weights. The categorization considers not only which individual thresholds were exceeded but also their relative magnitudes, temporal ordering indicating which violations appeared first, correlation patterns suggesting common underlying causes, and contextual information such as recent input characteristics or modality reliability. This comprehensive analysis produces a drift type classification that may identify a single primary cause or recognize compound drift scenarios requiring multiple coordinated responses.

At decision point 1224, the system performs drift type categorization decision branching to route the detected drift to the appropriate learning trigger. This multi-way decision tree represents one of the key architectural features of the disclosed system, enabling targeted, specific responses rather than generic retraining. The decision tree has multiple branches corresponding to different drift types, each leading to a specific learning trigger designed to address that particular failure mode.

When principal angles have exceeded thresholds, indicating spectral rotation, the system proceeds to step 1226 where it triggers spectral refresh to update the eigenvectors {φₖ}. This trigger signals that the landmark geometry has evolved sufficiently that the current spectral basis no longer provides an optimal coordinate system, and that recomputation of the spectral decomposition is warranted. The spectral refresh trigger packages information about which principal angles exceeded thresholds and by how much, the estimated rotation magnitude and direction, and recommendations for warm-start initialization to accelerate convergence. This trigger will invoke the spectral learning event method disclosed in FIG. 11, specifically entering at the spectral decomposition phase since landmark modification may not be required.

When high residuals have been detected in specific regions, indicating coverage gaps, the system proceeds to step 1228 where it triggers landmark promotion to expand the landmark set L. This trigger signals that the current landmark set fails to adequately represent one or more regions of the latent space, and that addition of new representative points is necessary to maintain projection quality. The landmark promotion trigger includes identification of high-residual regions through spatial clustering, candidate selection criteria based on centrality and representativeness, and coverage improvement estimates. This trigger will invoke the spectral learning event method at the landmark management phase, where new landmarks will be promoted before spectral recomputation.

When spectral gap collapse has been detected, indicating capacity saturation, the system proceeds to step 1230 where it triggers capacity expansion to increase the dimensionality m. This trigger signals that the current manifold dimensionality is insufficient to capture the complexity of accumulated experience, and that additional spectral modes must be retained. The capacity expansion trigger includes the current gap ratio and proposed new dimensionality based on the next natural gap in the eigenvalue spectrum, analysis of which structural variations cannot be captured in current dimensionality, and estimates of computational cost increase from expansion. This trigger will invoke modified spectral learning that retains additional eigenvectors beyond the previous truncation point.

When curvature or injectivity violations have been detected, indicating geometric distortion, the system proceeds to step 1232 where it triggers parameter adjustment to modify compression flow weights or other algorithmic parameters. This trigger signals that local manifold quality has degraded through accumulation of geometric inconsistencies, and that the balance between different optimization objectives should be adjusted. The parameter adjustment trigger includes specific geometric metrics that violated bounds, proposed adjustments to energy functional weights αᵢ to address distortions, and regions of the manifold where adjustments should be applied if local parameter tuning is supported. This trigger may not require spectral modification but rather adjustment of inference-time parameters to improve future projection quality.

These multiple trigger paths from step 1226, 1228, 1230, and 1232 converge to step 1234 where the system issues a learning trigger signal to the spectral learning event handler. This convergence point represents the transition from the inference-learning decision process to active learning execution. In an exemplary embodiment, the learning trigger signal may be explicitly labeled as “TRANSITION FROM INFERENCE TO LEARNING” because it marks the point where the system shifts from using existing spectral memory to modifying that memory. The learning trigger packages comprehensive information about the drift type categorized in step 1222, the specific invariants that exceeded thresholds with their magnitudes, the targeted learning operations determined by the decision tree routing, priority or urgency indicators based on severity of invariant violations, and contextual information such as current system load and available computational resources. The trigger may be issued immediately for critical violations requiring urgent response, or may be queued for execution during designated maintenance phases when larger spectral modifications can be performed without affecting real-time responsiveness. The issuance of this trigger represents a deliberate decision, based on objective geometric evidence, that the current spectral memory is inadequate and must be updated to maintain projection quality and geometric coherence.

In a step 1236, the system invokes a spectral learning event method such as the method disclosed in FIG. 11. This invocation transfers control to the spectral learning pipeline, which will perform the appropriate combination of landmark updates, spectral decomposition, plasticity constraint enforcement, and eigenspace alignment to update spectral memory. The invocation passes the learning trigger signal with all packaged information to guide the learning process, establishes monitoring contexts to track learning progress and outcomes, and prepares for subsequent synchronization when learning completes and updated spectral memory is broadcast. The explicit reference to FIG. 11 indicates that the detailed spectral learning procedures—including landmark management, kernel construction, warm-started eigendecomposition, plasticity bounds, and alignment—are executed as described in that method. Importantly, this step indicates that “spectrum will be modified,” emphasizing that the system is now performing learning rather than inference. During spectral learning execution, the inference-learning decision method may continue to process new inputs through inference using the current spectral basis, with appropriate concurrency control ensuring that spectral updates are applied atomically when learning completes. Alternatively, the system may pause inference operations during critical spectral updates to ensure consistency, with the specific concurrency strategy depending on system requirements and implementation constraints.

Upon completion or invocation of spectral learning, the method reaches an end state having successfully detected the need for learning based on objective geometric signals and triggered appropriate learning operations. The completion of this method does not mean the system stops—rather, inference-learning decision cycles continue indefinitely, with each cycle either confirming that the current spectral memory remains adequate or detecting new drift that requires learning. Following spectral learning completion, the system may reset monitoring baselines to the newly updated spectral basis, begin accumulating fresh statistics relative to the new spectral memory, and continue the continuous operational loop. The method thus implements an ongoing surveillance and adaptation mechanism that maintains projection quality over indefinite operational horizons by selectively triggering learning only when objective evidence warrants spectral modification.

The method 1200 embodies several design principles that distinguish the disclosed spectral learning architecture from conventional learning systems. First, the method implements strict separation between inference and learning through architectural routing, with the vast majority of operations proceeding through fast inference paths while learning occurs selectively based on monitored invariants. This separation enables efficient operation with bounded per-projection complexity while preserving adaptive capability. Second, the method uses objective geometric invariants rather than heuristic loss functions to detect when learning is necessary, providing mathematically principled signals that indicate structural inadequacy rather than arbitrary training schedules. Third, the method implements targeted, specific responses to different drift types rather than generic retraining, with different failure modes routed to appropriate learning operations that address root causes. Fourth, the method operates continuously without episodic training, with learning triggered by accumulated evidence rather than predetermined schedules, enabling adaptation to non-stationary environments. Fifth, the method maintains dual time scales with fast projection and slow monitoring, ensuring that computational resources are allocated appropriately with minimal overhead during normal operation and comprehensive analysis when evaluating whether learning is needed.

The continuous monitoring approach provides several advantages over conventional learning architectures. By accumulating statistics over monitoring windows rather than evaluating invariants after every projection, the system enables statistical reliability while minimizing computational overhead. The streaming statistical algorithms maintain bounded memory regardless of how many projections have been processed, enabling indefinite operation. The comprehensive suite of geometric invariants—principal angles, spectral gaps, curvature, residuals—provides multiple independent signals that together give robust detection of various drift modalities. The categorization of drift types enables intelligent routing to targeted fixes rather than applying one-size-fits-all updates. The threshold-based triggering implements objective, interpretable criteria for when learning is necessary, avoiding the ad hoc decisions inherent in validation loss monitoring under nonstationarity.

The method further demonstrates how spectral learning naturally supports long-horizon operation. Because learning modifies spectral memory rather than local parameters, each learning event updates the global geometric structure in a coordinated, coherent manner. The warm-started spectral updates ensure that learning builds incrementally on previous structure rather than starting anew. The plasticity bounds enforced during learning prevent catastrophic forgetting by limiting how much spectral memory can change. The eigenspace alignment maintains continuity of reasoning across learning events. These properties combine to enable stable accumulation of experience into spectral memory without the degradation, catastrophic forgetting, or unbounded complexity growth that plague conventional approaches.

By implementing learning as a selective, targeted response to objective geometric signals rather than as continuous parameter modification, method 1200 supports a fundamentally different operational paradigm. The system spends most of its time in efficient inference mode, using existing spectral memory without modification. Learning occurs only when measured invariants provide evidence that spectral memory is inadequate. This evidence-based, selective learning enables stable, long-horizon operation with interpretable triggers and targeted responses. The method demonstrates that effective learning does not require continuous parameter updates during every data encounter, but can instead be realized through deliberate, infrequent modifications of spectral structure triggered by objective geometric monitoring. This approach is particularly well-suited for persistent cognitive machines that must operate continuously over extended time horizons, maintaining stable inference while adapting to genuine structural changes in accumulated experience.

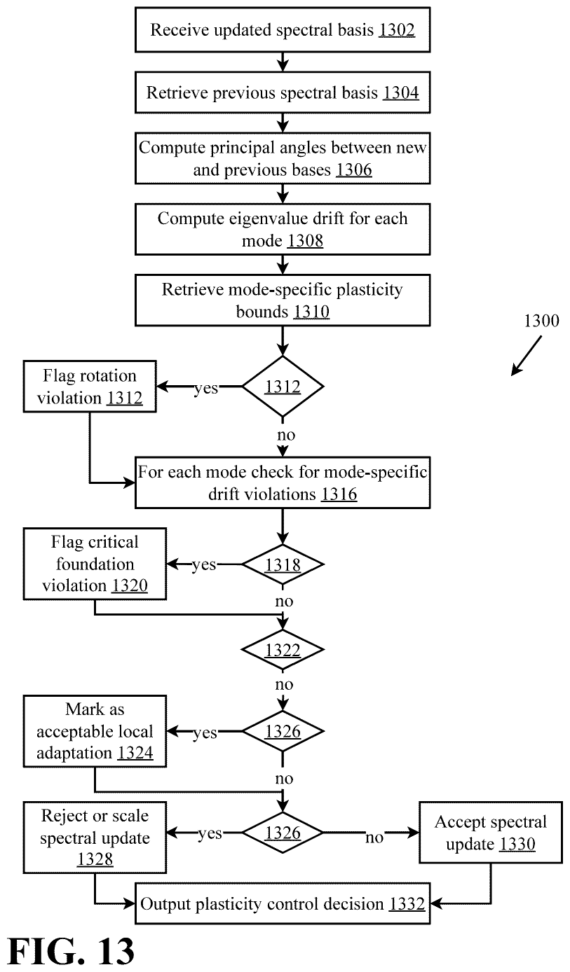

FIG. 13 is a flow diagram illustrating an exemplary method for spectral plasticity control within an adaptive spectral learning system, according to an embodiment. The method 1300 represents an implementation of a safeguard mechanism that prevents catastrophic forgetting by enforcing bounded modifications to spectral memory during learning events. The method implements frequency-dependent plasticity bounds that protect foundational, low-frequency spectral modes representing long-term abstractions while permitting greater adaptation in higher-frequency modes encoding local detail. This differential treatment enables the system to accumulate new experiences and adapt to structural changes without destroying previously learned semantic organization. The method 1300 embodies the principle that spectral memory should evolve gradually and continuously rather than through disruptive jumps, with tight constraints on global structure and looser constraints on fine-grained variations.

According to the embodiment, the process begins when the spectral plasticity control method is initiated following computation of an updated spectral basis by the spectral learning core. This initiation occurs after eigendecomposition has produced new eigenvectors and eigenvalues but before these updates are accepted and broadcast system-wide. The plasticity control method serves as a gatekeeper, evaluating whether the proposed spectral update satisfies stability constraints that prevent catastrophic forgetting. The method operates on the principle that not all spectral updates should be accepted—those that would disrupt foundational structure or cause excessive rotation of the coordinate system must be rejected, scaled, or deferred to maintenance phases where larger changes are permissible. The initiation establishes comparison contexts, retrieves historical spectral bases for drift quantification, and prepares violation tracking flags that will determine the final accept/reject decision.

In a step 1302, the system receives the updated spectral basis comprising new eigenvectors {φ′ₖ} and new eigenvalues {λ′ₖ} from the spectral learning core following eigendecomposition. These updated spectral structures represent the proposed new memory state that would result from incorporating recent landmark changes and accumulated experience into the spectral representation. The eigenvectors {φ′ₖ} for k=1, . . . , m define a new coordinate system for the cognitive manifold, with each eigenvector representing a direction of variation in the semantic space. The eigenvalues {λ′ₖ} characterize the geometric stiffness or resistance associated with motion along each eigenvector direction, with small eigenvalues corresponding to smooth, slowly varying directions and larger eigenvalues corresponding to rapidly oscillating or locally constrained directions. The updated basis has been computed through warm-started iterative eigendecomposition of the graph Laplacian constructed on the current landmark set, as described in the spectral learning event method. The reception of this updated basis triggers the plasticity control evaluation to determine whether the changes relative to the previous basis fall within acceptable bounds or whether they violate stability constraints.

In a step 1304, the system retrieves the previous spectral basis comprising eigenvectors {φₖ} and eigenvalues {λₖ} from the spectral memory store for comparison and drift quantification. The previous basis represents the spectral memory state prior to the current learning event and serves as the reference against which changes are measured. This basis was established during the previous spectral learning event or during system initialization and has been serving as the coordinate system for all inference operations since that time. The retrieval accesses the spectral memory store, which maintains not only the current operational basis but also recent historical bases to support drift tracking and stability analysis. The previous eigenvectors {φₖ} are arranged as columns of a matrix Φ∈R^{n×m} where n is the number of landmarks and m is the retained dimensionality, with eigenvectors orthonormal such that Φ^{T}Φ=I. The previous eigenvalues {λₖ} form a vector λ∈R^{m} ordered from smallest to largest. If the landmark set has changed between the previous and current learning events, the retrieval process may need to project or interpolate the previous eigenvectors onto the current landmark set to enable meaningful comparison. The retrieved previous basis provides the baseline for computing principal angles that quantify rotation and eigenvalue drifts that quantify stiffness changes.

In a step 1306, the system computes principal angles θᵢ between the new and previous spectral bases via singular value decomposition, specifically computing cos θᵢ=σᵢ((Φ′)^{T}Φ) where σᵢ are the singular values obtained from SVD. Principal angles provide a mathematically rigorous measure of how much the spectral coordinate system has rotated during the learning event. The computation begins by forming the m×m matrix product (Φ′)^{T}Φ, which captures the inner products between corresponding eigenvectors in the new and previous bases. If both bases are orthonormal and identical, this matrix would be the identity I; departures from identity indicate rotation. Singular value decomposition of this matrix yields (Φ′)^{T}Φ=UΣV^{T} where U and V are orthogonal matrices and Σ is a diagonal matrix containing singular values σᵢ. The singular values lie in the range [0,1], with σᵢ=1 indicating that the i-th subspace is unchanged and σᵢ<1 indicating rotation. The principal angles are defined as θᵢ=arccos(σᵢ), yielding angles in the range [0°, 90°]. Small principal angles near zero indicate that the new basis is a minor perturbation of the previous basis, suggesting incremental refinement of spectral memory. Large principal angles approaching ninety degrees indicate substantial rotation, suggesting that the landmark geometry has changed significantly and the spectral coordinates have undergone major reorganization. The maximum principal angle max θᵢ provides a single scalar measure of the worst-case rotation, which will be compared against a stability threshold. The distribution of principal angles across modes provides additional insight, with some modes potentially remaining stable while others rotate more substantially. This computation quantifies spectral rotation and provides one of the key signals for catastrophic forgetting prevention.

In a step 1308, the system computes eigenvalue drift for each spectral mode as Δλₖ=|λ′ₖ−λₖ| for k=1, . . . , m, measuring how much the geometric stiffness associated with each spectral direction has changed. Eigenvalue drift quantifies whether modes have become more or less important, more or less coherent, or have changed their relative ordering. The computation evaluates the absolute difference between corresponding eigenvalues in the new and previous bases for each retained mode. Small eigenvalue drifts indicate that the geometric properties of each spectral direction have remained stable, while large drifts indicate significant changes in how information is distributed across modes. The eigenvalue drift is computed separately for each mode k because different modes are subject to different plasticity bounds—low-frequency modes encoding foundational abstractions should exhibit minimal drift, while higher-frequency modes encoding local detail may exhibit greater drift without causing concern. The eigenvalue drifts {Δλₖ} will be compared against mode-specific bounds εₖ in subsequent steps. Eigenvalue drift also provides information about whether new structure is emerging or existing structure is consolidating: increasing eigenvalues suggest that a mode is becoming more important or coherent, while decreasing eigenvalues suggest diminishing importance or potential redundancy with other modes. The computation produces a vector of drifts Δλ∈R^{m} that characterizes the magnitude of change in geometric stiffness across all spectral modes.

In a step 1310, the system retrieves mode-specific plasticity bounds including θₘ_{ₐₓ}, the maximum allowable principal angle, and εₖ for each mode k, the eigenvalue drift bound for that mode. These bounds implement a mechanism of differential plasticity that enables learning while preventing catastrophic forgetting. The plasticity bounds may be configured based on theoretical requirements for manifold stability, empirical observations of stable operating regions during system development, and adaptive policies that may tighten or relax bounds based on operational context. The maximum principal angle threshold θₘ_{ₐₓ} is typically set in the range of five to fifteen degrees, balancing the goals of preserving continuity of the coordinate system against allowing adaptation to structural changes. Smaller values of θₘ_{ₐₓ} enforce stronger continuity but may prevent the system from adapting to genuine distributional shifts, while larger values permit more flexible adaptation but risk disrupting established semantic relationships. The eigenvalue drift bounds εₖ are mode-specific and frequency-dependent, implementing differential protection across the spectral hierarchy. For low-frequency modes with indices k≤k₀, where k₀ represents a boundary between foundational and detail modes, the bounds are tight: εₖ is small, often on the order of one to five percent of the eigenvalue magnitude, ensuring that global structure evolves slowly. For high-frequency modes with indices k>k₀, the bounds are looser: εₖ may be ten to twenty percent or more of the eigenvalue magnitude, permitting faster adaptation of fine-grained structure. This frequency-dependent treatment reflects the principle that low-frequency eigenvectors encode stable, long-term abstractions representing foundational semantic organization that should be preserved across learning events, while high-frequency eigenvectors encode recent, contextual, or local patterns that may legitimately change more rapidly as new experiences arrive. The boundary index k₀ may be set statically based on the overall dimensionality m, or may be determined adaptively based on spectral gap analysis identifying a natural division between global and local modes. The retrieval of these bounds prepares the subsequent violation checking steps to enforce differential plasticity.

At decision point 1312, the system evaluates whether the maximum principal angle exceeds the threshold by checking if max θᵢ>θₘ_{ₐₓ}, indicating excessive rotation of the spectral coordinate system. This check identifies whether the spectral basis has rotated so much that the new coordinates would be substantially different from the old coordinates, potentially disrupting reasoning trajectories, stored similarities, and semantic relationships that depend on coordinate continuity. The evaluation examines the principal angles θᵢ computed in step 1306, identifies the maximum angle max θᵢ=max{θ₁, . . . , θₘ}, and compares it against the threshold θₘ_{ₐₓ}. If the maximum angle is less than or equal to the threshold, the rotation is considered acceptable and represents incremental refinement that preserves coordinate continuity. If the maximum angle exceeds the threshold, the rotation is considered excessive and indicates that the spectral update would cause a disruptive reorganization of the coordinate system. Excessive rotation can occur when landmark changes are too large relative to the landmark set size, when multiple correlated modes rotate simultaneously, or when distributional shift introduces genuinely new structure that cannot be accommodated through small perturbations of the existing basis. The decision branches based on whether rotation is excessive, with excessive rotation flagged for special handling.

In a step 1314, when the maximum principal angle exceeds the threshold, the system flags a rotation violation, for example, by setting rotation_{violated}=TRUE. This flag indicates that the proposed spectral update would cause excessive rotation of the coordinate system and therefore requires special handling to prevent disruption of established semantic relationships. The flagging mechanism records which principal angles exceeded thresholds, by how much they exceeded thresholds, and whether the violation involves multiple correlated modes or a single anomalous mode. The rotation violation flag will contribute to the final accept/reject decision in step 1326, where it may trigger rejection of the entire update, scaling of the update to bring the rotation within bounds, or deferral of the update to a maintenance phase where larger changes are permitted. The flagging does not immediately reject the update because eigenvalue drift constraints must also be evaluated, and the combination of rotation and drift violations determines the appropriate response. The flag is maintained as the method proceeds to eigenvalue drift checking.

When the maximum principal angle does not exceed the threshold at decision point 1312, the method proceeds directly without setting the rotation violation flag, indicating that rotation is within acceptable bounds. The two paths—flagged rotation violation and acceptable rotation—converge before proceeding to eigenvalue drift evaluation, as both rotation and drift must be assessed to make a comprehensive plasticity decision.

In a step 1316, the system checks eigenvalue drift by mode, evaluating for each mode k=1, . . . , m whether the drift Δλₖ computed in step 1308 exceeds the mode-specific bound εₖ retrieved in step 1310. This per-mode evaluation enables detection of which spectral directions have changed significantly and whether those changes violate the differential plasticity constraints. The evaluation loops through all retained modes, comparing Δλₖ>εₖ for each mode k. Modes for which the drift is within bounds are considered stable; modes for which the drift exceeds bounds are considered to have violated plasticity constraints. The evaluation separately tracks violations in low-frequency modes versus high-frequency modes because they have different implications for stability and forgetting. The per-mode checking produces a set of violation indicators identifying which modes exceeded their bounds, enabling targeted analysis of whether violations affect foundational structure or merely fine-grained detail.

At decision point 1318, the system determines whether any low-frequency mode with index k≤k₀ has violated its eigenvalue drift bound, indicating a critical foundation violation. Low-frequency modes represent the global, stable, long-term semantic structure of accumulated experience, encoding fundamental abstractions and relationships that should remain coherent across learning events. Violations of low-frequency mode bounds suggest that foundational structure is changing, which could indicate catastrophic forgetting where new learning overwrites essential prior knowledge. The decision examines the violation indicators from step 1316, identifies any modes k≤k₀ for which Δλₖ>εₖ, and flags such violations as critical because they affect the foundation of spectral memory. Low-frequency violations are particularly concerning because these modes have the tightest bounds εₖ, meaning that even a violation represents a substantial proportional change to a mode that should be highly stable. If low-frequency violations are detected, the method branches to flag critical foundation violation; otherwise, it proceeds to check high-frequency violations.

In a step 1320, when low-frequency mode violations are detected, the system flags a critical foundation violation, for example, by setting foundation_{violated}=TRUE. This flag indicates that the proposed spectral update would significantly alter foundational semantic structure, raising severe concerns about catastrophic forgetting. The flagging mechanism records which low-frequency modes violated bounds, the magnitude of violations, and whether violations are isolated to a single mode or affect multiple foundational modes simultaneously. Critical foundation violations typically require rejection of the spectral update, as accepting such updates would risk destroying the stable abstractions that enable long-term reasoning and semantic coherence. In some implementations, severe foundation violations may trigger emergency responses such as reverting to an earlier spectral basis, initiating diagnostic analysis to identify the cause of instability, or signaling for human oversight. The foundation violation flag will contribute decisively to the final accept/reject decision, as it represents the most serious form of plasticity violation.

When no low-frequency violations are detected at decision point 1318, the method proceeds to check whether high-frequency modes have violated their bounds. The paths from low-frequency violation flagging and no low-frequency violations converge before high-frequency checking.

At decision point 1322, the system determines whether any high-frequency mode with index k>k₀ has violated its eigenvalue drift bound. High-frequency modes represent local, fine-grained, or recent semantic structure that encodes details, context, or transient patterns rather than foundational abstractions. These modes have looser plasticity bounds εₖ reflecting the expectation that local structure may legitimately change more rapidly than global structure as new experiences arrive. The decision examines violation indicators for modes k>k₀, identifying any for which Δλₖ>εₖ. Unlike low-frequency violations which are critical, high-frequency violations are not necessarily concerning because they may represent appropriate adaptation to new local structure. However, the system still tracks these violations to distinguish between spectral updates that changed nothing, updates that changed only high-frequency detail, and updates that changed foundational structure. If high-frequency violations are detected, the method branches to mark them as acceptable adaptation; otherwise, it proceeds recognizing that all modes are within bounds.

In a step 1324, when high-frequency mode violations are detected, the system marks the spectral update as involving acceptable local adaptation. This marking indicates that while eigenvalue drift bounds were exceeded, the violations affected only high-frequency modes where higher plasticity is permitted by design. The step records which high-frequency modes violated bounds and the magnitude of violations, but classifies these violations as expected and acceptable rather than problematic. High-frequency violations often indicate that the system is successfully incorporating novel local structure, refining contextual patterns, or adapting fine-grained distinctions based on recent experience—all of which are desirable learning behaviors that should not be prevented. The marking as acceptable local adaptation contributes positively to the plasticity decision, as it indicates that learning is occurring in the appropriate spectral modes rather than disrupting foundations. This step embodies the principle of differential plasticity: strict protection of low-frequency foundations combined with flexible adaptation of high-frequency details.

When no high-frequency violations are detected at decision point 1322, the method proceeds recognizing that all eigenvalue drifts are within their respective bounds, indicating that the spectral update represents minimal change to geometric stiffness across all modes. The paths from acceptable high-frequency adaptation and no high-frequency violations converge before the final plasticity decision.

At decision point 1326, the system performs the critical final evaluation by checking, for instance, whether rotation_{violated} OR foundation_{violated}, determining whether any critical plasticity constraints have been violated. This decision synthesizes the results of all previous checks—rotation magnitude from step 1312 and foundation mode drift from step 1318—to make the ultimate accept/reject determination. In some implementations, the decision may use logical OR because violation of either rotation bounds or foundation mode bounds is sufficient to trigger rejection or scaling of the update. If rotation_{violated} is TRUE, indicating that max θᵢ>θₘ_{ₐₓ}, the spectral coordinate system has rotated excessively and accepting the update would disrupt semantic continuity. If foundation_{violated} is TRUE, indicating that one or more low-frequency modes exceeded their tight drift bounds, foundational structure is changing in ways that risk catastrophic forgetting. Either condition represents a critical failure to satisfy plasticity constraints. If both flags are FALSE, indicating that rotation is acceptable and all low-frequency modes are within bounds, then the spectral update satisfies stability requirements and can be accepted. The presence of acceptable high-frequency adaptation marked in step 1324 does not trigger rejection because high-frequency changes are permitted. This final decision implements the gatekeeper function of plasticity control, preventing updates that would destroy prior knowledge while permitting updates that refine or extend knowledge appropriately.

In a step 1328, when either rotation violation or foundation violation has been flagged, the system rejects or scales the spectral update to prevent catastrophic forgetting. This step implements the core protective function of plasticity control by declining to accept spectral changes that violate stability constraints. The rejection or scaling decision depends on the severity and nature of violations. For moderate violations where bounds are exceeded by small margins, the system may apply a scaling factor to the spectral rotation, computing an intermediate basis Φ″ that represents a partial rotation from Φ toward Φ′, such that the principal angles to Φ are exactly at threshold θₘ_{ₐₓ} and eigenvalue drifts are proportionally reduced. This scaled update allows partial incorporation of the structural change while maintaining continuity. For severe violations where multiple bounds are exceeded by large margins or where foundation violations involve multiple low-frequency modes, the system may reject the entire spectral update, retaining the previous basis Φ unchanged and logging the rejection for analysis. The rejection indicates that the proposed learning event would be too disruptive and that the evidence for change must accumulate further before updating spectral memory. For critical violations during normal operation, the system may defer the update to a designated maintenance or consolidation phase where larger plasticity bounds are permitted, essentially queueing the structural change for later incorporation under more permissive conditions. The rejection or scaling mechanism ensures that learning proceeds gradually and continuously, with each individual update limited in magnitude to preserve stability, while allowing larger cumulative changes to emerge through multiple bounded updates over time. This step explicitly prevents catastrophic forgetting by enforcing that spectral memory evolution respects frequency-dependent bounds, with foundational structure protected by tight constraints and detail structure permitted greater flexibility.

In a step 1330, when neither rotation nor foundation violations have been flagged, the system accepts the spectral update, recognizing that plasticity bounds are satisfied and the proposed changes fall within acceptable limits. This acceptance confirms that the new spectral basis {φ′ₖ}, {λ′ₖ} can safely replace the previous basis without risking catastrophic forgetting or disrupting established semantic relationships. The acceptance indicates that rotation magnitude is below θₘ_{ₐₓ}, ensuring coordinate continuity; that all low-frequency modes have eigenvalue drifts below their tight bounds εₖ for k≤k₀, ensuring foundational stability; and that any high-frequency eigenvalue drifts, while potentially exceeding their looser bounds, represent acceptable local adaptation. The accepted update will proceed to eigenspace alignment and broadcast to all system components, enabling all future inference and reasoning to operate on the refined spectral memory. The acceptance embodies successful learning—structural refinement that improves representational quality while preserving prior knowledge through bounded evolution of spectral geometry.

Both the rejection/scaling path from step 1328 and the acceptance path from step 1330 converge to step 1332, where the system outputs the plasticity control decision along with either the updated spectral basis if accepted or a rejection flag if not accepted. The output communicates the results of plasticity control to the spectral learning pipeline and to monitoring systems. For accepted updates, the output includes the new spectral basis {φ′ₖ}, {λ′ₖ} confirmed to satisfy stability constraints, plasticity metrics including maximum principal angle, eigenvalue drift magnitudes, and which modes if any exhibited acceptable high-frequency adaptation, and acceptance timestamp and version information for consistency tracking. For rejected or scaled updates, the output includes the rejection or scaling decision with rationale based on which bounds were violated, the scaled intermediate basis Φ″ if scaling was applied, recommendations for next steps such as deferral to maintenance phase or accumulation of additional evidence, and diagnostic information about the nature and severity of violations. The output enables downstream components to proceed appropriately: the eigenspace alignment module will receive either the accepted new basis or the retained previous basis, the spectral memory store will either update or maintain its current state, and the drift monitoring system will adjust thresholds or window sizes if repeated rejections indicate excessively conservative bounds. The comprehensive output ensures that plasticity control decisions are transparent, traceable, and actionable.

Upon completion of output, the method reaches an end state, having successfully evaluated the proposed spectral update against plasticity constraints and determined whether it can be safely accepted or must be rejected or scaled. The completion of this method represents an important control point in the spectral learning process—it is here that the system enforces the balance between stability and plasticity, between preserving prior knowledge and incorporating new structure. The method does not terminate the learning process but rather gates whether a specific spectral update proceeds to broadcast and integration. If the update was accepted, the spectral learning event method will continue with eigenspace alignment and system-wide broadcast. If the update was rejected, the spectral learning event may terminate with the previous basis retained, or may iterate with adjusted parameters to produce a bounded update that satisfies constraints. The method may be invoked multiple times during iterative spectral refinement or adaptive bound adjustment, providing continuous plasticity monitoring throughout learning.

The method 1300 embodies several design principles that distinguish the disclosed plasticity control approach from conventional regularization mechanisms. First, the method implements explicit, mathematically defined bounds on spectral change rather than relying on implicit regularization through loss functions or hyperparameter tuning. The bounds on principal angles and eigenvalue drift are directly interpretable and can be set based on theoretical stability requirements. Second, the method enforces differential plasticity across spectral modes, with frequency-dependent bounds that protect low-frequency foundations while permitting high-frequency adaptation. This reflects the natural hierarchy of semantic structure where global abstractions should be stable and local details may vary. Third, the method operates as a hard constraint rather than a soft penalty, actually rejecting or scaling updates that violate bounds rather than merely discouraging violations through increased loss. This ensures that catastrophic forgetting is prevented by design rather than statistically likely to be avoided. Fourth, the method provides transparency and interpretability by explicitly tracking which bounds were violated, which modes were affected, and why updates were rejected or accepted. This enables offline analysis, tuning of bounds, and debugging of learning dynamics. Fifth, the method integrates naturally with the warm-started spectral learning process, evaluating updates produced by eigendecomposition before they are broadcast, ensuring that only bounded updates propagate through the system.

The frequency-dependent plasticity bounds implement a key insight about the structure of long-term memory: not all memory is equally plastic. Foundational, abstract, global structure—encoded in low-frequency spectral modes—should be highly stable, changing only slowly as massive amounts of evidence accumulate. Detailed, specific, local structure—encoded in high-frequency modes—can and should adapt more rapidly to recent experience. This differential treatment enables the system to simultaneously maintain stable core knowledge and flexibly incorporate new information, resolving the stability-plasticity dilemma that plagues conventional learning systems. By protecting low-frequency modes with tight bounds εₖ for k≤k₀, the system prevents catastrophic forgetting where new learning overwrites essential abstractions. By permitting higher plasticity in high-frequency modes with loose bounds εₖ for k>k₀, the system enables responsive adaptation to novel details and contexts.

The reject/scale/accept decision framework provides graduated responses to plasticity violations rather than binary reject/accept. Moderate violations can be accommodated through scaling, allowing partial incorporation of structural change while maintaining stability. Severe violations trigger outright rejection, protecting memory integrity. Acceptable high-frequency violations are recognized as desirable learning rather than failures. This nuanced approach enables the system to adapt continuously while respecting hard bounds on foundational change.

By implementing plasticity control as an integral component of spectral learning, the method 1300 enables learning that is simultaneously stable and adaptive. The system can accumulate unbounded experience into bounded spectral memory without suffering catastrophic forgetting, degradation, or instability. Long-term reasoning remains coherent because foundational structure is protected. Recent learning is incorporated because detail structure is adaptive. This approach is particularly well-suited for persistent cognitive machines that must operate continuously over extended periods, learning from ongoing experience while preserving essential prior knowledge through frequency-dependent plasticity bounds that mirror the natural hierarchy of semantic structure.

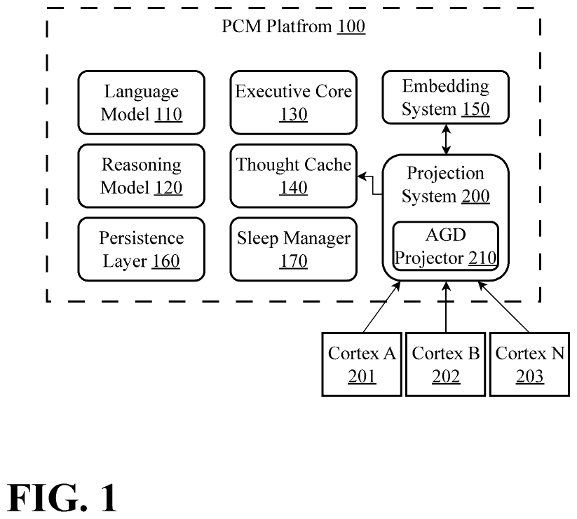

FIG. 1 is a block diagram illustrating the integration of an adaptive geometric diffusion projection system within a persistent cognitive machine architecture, according to an embodiment. The adaptive geometric diffusion projection system 200 represents a fundamental advancement in projection mechanisms for artificial intelligence systems by providing a purely geometric approach to mapping heterogeneous, high-dimensional latent representations onto a shared semantic manifold. Unlike conventional dimensionality reduction techniques that rely on neural network parameterizations or static transformations, the system 200 maintains geometric coherence through adaptive spectral methods while handling chaotic distributional drift without requiring retraining.

At the architectural level, adaptive geometric diffusion projection system 200 operates as an integrated component within the broader persistent cognitive machine platform 100. The PCM platform 100, shown in dashed outline to indicate contextual architecture, comprises several core components including a language model 110 for natural language processing capabilities, a reasoning model 120 for complex analytical tasks, an executive core 130 for orchestrating cognitive processes, a thought cache 140 for storing and organizing cognitive content, an embedding system 150 for vector representations, a persistence layer 160 for maintaining state across system restarts, and a sleep manager 170 for cognitive maintenance operations. The adaptive geometric diffusion projection system 200 interfaces primarily with the embedding system 150 through a bidirectional connection that enables coordinated transformation of representations, and provides output to the thought cache 140 in the form of manifold coordinates that preserve semantic relationships.

The primary function of adaptive geometric diffusion projection system 200 is to serve as a projection operator that transforms multiple heterogeneous input streams into a unified geometric representation. The system receives input from a plurality of cortices, shown as cortex 201, cortex 202, through cortex N 203, each producing latent representations in distinct high-dimensional spaces denoted as S\hat{ }(1), S\hat{ }(2), through S\hat{ }(N) respectively. These cortices may operate in different modalities such as visual processing, auditory analysis, linguistic understanding, temporal reasoning, or other specialized cognitive domains. Each cortex generates latent states with its own dimensional characteristics, distributional properties, and semantic structure, creating a fundamental challenge for unified representation within the cognitive architecture.

The adaptive geometric diffusion projection system 200 addresses this challenge through its core component, the AGD projector 210, which implements a sophisticated geometric transformation. The AGD projector 210 receives the heterogeneous latent spaces S\hat{ }(N) from the various cortices and maps them onto a shared semantic manifold M, where M is embedded in a low-dimensional space with dimension m significantly smaller than any of the input dimensions. This projection is not merely a dimensionality reduction but a semantic reorganization that ensures points close together on the manifold M represent semantically similar concepts, even if they originated from different cortices or were distant in their original latent spaces.

The output of AGD projector 210 is the semantic manifold M, which serves as a unified geometric substrate for cognitive operations within the PCM platform. This manifold is characterized by several properties: it is smooth and differentiable almost everywhere, supporting the computation of geodesics that represent cognitively meaningful trajectories; it preserves semantic relationships through its Riemannian metric structure; and it maintains topological coherence despite the continuous influx of new data points from the streaming cortex inputs. The manifold M feeds directly into the thought cache 140, where manifold coordinates are stored and organized for retrieval during cognitive processes.

The integration between adaptive geometric diffusion projection system 200 and the PCM platform 100 is further enhanced through control signals from executive core 130, which may influence projection parameters, trigger adaptation mechanisms, or request specific projections based on current cognitive requirements. This bidirectional communication ensures that the projection system operates in harmony with the broader cognitive processes of the platform, adapting its geometric structures to support the current cognitive context while maintaining long-term semantic coherence.

In operation, the adaptive geometric diffusion projection system 200 provides several capabilities to the persistent cognitive machine architecture. First, it enables the unification of diverse cognitive modalities into a common geometric framework, allowing the system to reason across different types of information seamlessly. Second, it maintains this unification adaptively, handling the natural drift and evolution of latent representations without requiring periodic retraining or catastrophic forgetting. Third, it provides a computationally efficient transformation with complexity that scales logarithmically with accumulated experiences, ensuring long-term viability. These capabilities make the adaptive geometric diffusion projection system 200 an essential component for any cognitive architecture that must integrate multiple sources of high-dimensional information into a coherent, persistent representation.

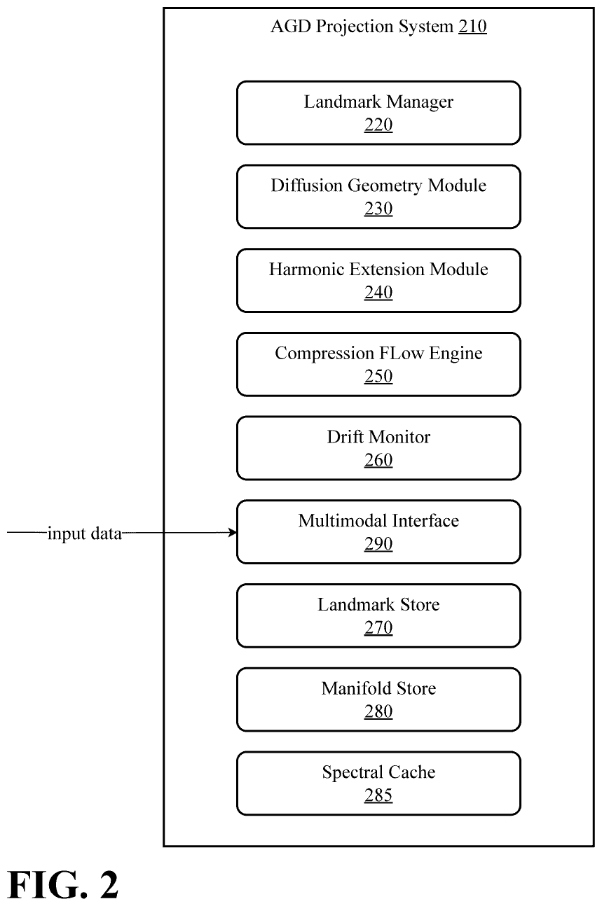

FIG. 2 is a block diagram illustrating an exemplary system architecture for an adaptive geometric diffusion projection system, according to an embodiment. AGD projector 210 implements a multi-layer geometric transformation pipeline that operates without learned weights or neural network parameterizations. Unlike traditional projection mechanisms that require training and retraining to maintain coherence, AGD projector 210 achieves adaptive projection through purely geometric operations that naturally handle distributional drift, multimodal inputs, and streaming data while maintaining mathematical guarantees about manifold structure and semantic coherence.

AGD projector 210 can be configured to carefully orchestrate collection of modules that transform high-dimensional, heterogeneous latent representations into a unified low-dimensional manifold. The architecture comprises various computational modules and one or more storage components, all designed to operate efficiently on modern GPU hardware while maintaining the geometric invariants necessary for reliable projection. These components enable the systems and methods described herein to realize a projection operator that is simultaneously adaptive to changing distributions, transparent in its operations through explicit geometric monitoring, and computationally efficient with logarithmic scaling in accumulated experiences.

A multimodal interface 290 serves as the entry point for diverse latent representations from multiple cortices. This component receives input streams S^{j} from various cortical sources, each potentially having different dimensionality, distributional characteristics, and semantic structure. Multimodal interface 290 maintains modality-specific semantic metrics d^{j}ₛₑₘ that capture the notion of similarity appropriate to each cortex type—for instance, perceptual similarity for visual cortices, syntactic similarity for language cortices, or temporal proximity for sequence-processing cortices. The interface also manages modality weights that reflect the current reliability or importance of each input stream, allowing the system to dynamically adjust its reliance on different cortices based on their stability or relevance. These weights feed into the construction of composite kernels that unify information across modalities while respecting their individual characteristics.

Working in close coordination with the multimodal interface is a landmark manager 220, which maintains a compact set of representative points L that serve as the skeletal structure for the geometric projection. Landmark manager 220 implements adaptive selection strategies to ensure that the landmark set provides adequate coverage of the data distribution while remaining computationally tractable. The size of the landmark set is typically much smaller than the number of data points, following the scaling relationship |L|=mₗ«N, where N is the number of retained manifold points. The landmark manager continuously monitors the quality of landmark coverage through residual statistics and can promote new landmarks when novel regions of the latent space are discovered. This adaptive landmark maintenance ensures that the projection remains accurate even as the underlying data distribution evolves over time.

Central to the geometric transformation is a diffusion geometry module 230, which constructs and maintains the spectral representation of the landmark graph. This module can be configured to build a semantic kernel K that combines affinity information from all modalities according to their respective weights and semantic metrics. From this kernel, diffusion geometry module 230 computes the normalized graph Laplacian L_{L} and performs spectral decomposition (also referred to herein as eigen decomposition) to obtain eigenvalues and eigenvectors. The resulting spectral coordinates Ψc provide a natural parameterization of the manifold that respects the intrinsic geometry of the data rather than its ambient representation. The module selects the top m eigenvectors based on spectral gap analysis, ensuring that the chosen dimensionality captures the essential structure while filtering noise and redundant variations. These spectral coordinates form the canonical basis for the semantic manifold M.

For streaming operation, a harmonic extension module 240 provides the mechanism to attach new data points to the existing manifold structure without global recomputation. When a new point x arrives from cortex j, harmonic extension module 240 identifies the L nearest landmarks in the modality-specific semantic metric and computes attachment weights using an exponential kernel w^{j}ₓₗ=exp(−κⱼd^{j}ₛₑₘ(x, l)). The module then solves a discrete Dirichlet problem to find coordinates that are harmonic with respect to the landmark coordinates, effectively interpolating the new point's position based on its semantic relationships to known landmarks. This process has a closed-form solution as a weighted barycenter, enabling constant-time attachment of new points regardless of the total number of experiences processed. The harmonic extension provides a principled first approximation for the manifold embedding of incoming data.

While harmonic extension provides rapid initial placement, a compression flow engine 250 refines these coordinates to ensure local geometric coherence and global manifold quality. This module implements a constrained gradient flow driven by a geometric energy functional that balances multiple objectives: semantic coherence that keeps semantically related points close on the manifold; curvature regularization that prevents excessive folding or stretching of the manifold; density management that avoids both overcrowding and sparse regions; and chart conditioning that maintains well-behaved local coordinate systems. The flow evolves manifold coordinates through small steps projected onto estimated tangent spaces, ensuring that updates remain on the manifold and preserve its topological structure. The compression flow engine 250 operates locally, updating only neighborhoods affected by new data, which maintains the logarithmic scaling property of the overall system.

Supporting the stability and reliability of the projection is a drift monitor 260, which continuously tracks geometric invariants and triggers adaptive responses when necessary. Drift monitor 260 computes and monitors several key metrics including, but not limited to: principal angles between successive spectral bases to detect when the landmark geometry has shifted significantly; spectral gap ratios to ensure adequate separation between the retained and discarded dimensions; curvature distributions to prevent pathological manifold geometries; injectivity radii to maintain local homeomorphism; and residual statistics from harmonic extension to identify regions requiring new landmarks. When any monitored invariant exceeds predetermined thresholds, drift monitor 260 signals the appropriate module, such as triggering landmark manager 220 to refresh landmarks or prompting diffusion geometry module 230 to update spectral coordinates. This monitoring system provides objective, geometrically-grounded criteria for adaptation, avoiding the ad hoc heuristics common in neural network-based projectors.

Supporting the computational modules are three storage components optimized for GPU-resident operation. The landmark store 270 maintains the current landmark set and associated metadata in high-bandwidth memory, enabling rapid nearest-neighbor queries and kernel computations. The manifold store 280 holds the coordinates of all active points on the manifold M, organized for efficient neighborhood queries and updates during compression flow. Specifically, manifold store 280 incorporates a nearest neighbor index structure such as a k-d tree, ball tree, or HNSW graph that supports constant-time local neighborhood identification. This index is incrementally maintained as new points are projected, with updates affecting only local graph or tree structures rather than requiring global reorganization. The spectral cache 285 stores the eigenvectors and eigenvalues from the diffusion geometry module, supporting both the harmonic extension of new points and the monitoring of spectral drift. These storage components are designed to minimize memory transfers and maximize parallelism in GPU execution while supporting the local update patterns essential to streaming operation.

The data flow through AGD projector 210 follows a carefully orchestrated pipeline, according to an embodiment. Input streams from multiple cortices enter through multimodal interface 290, which routes them to harmonic extension module 240 for initial coordinate assignment. The harmonic extension module queries landmark store 270 via landmark manager 220 and utilizes spectral coordinates from diffusion geometry module 230. Initial coordinates then pass to compression flow engine 250 for refinement, with the final manifold points stored in manifold store 280. Throughout this pipeline, drift monitor 260 observes all operations and maintains statistics, triggering refresh signals to landmark manager 220 when adaptation is necessary. This creates a self-regulating system that maintains geometric coherence without external intervention.

The architecture of AGD projector 210 embodies several design principles that distinguish it from conventional projection methods. First, the separation of global structure (captured by landmark spectral geometry) from local attachment (via harmonic extension) and refinement (through compression flow) enables efficient streaming operation. Second, the use of explicit geometric operations rather than learned parameters provides transparency and theoretical guarantees about projection quality. Third, the comprehensive monitoring system ensures that the projector adapts to changing conditions based on objective mathematical criteria rather than heuristic loss functions. These principles combine to create a projection system that is simultaneously adaptive, reliable, and computationally efficient, meeting the demanding requirements of persistent cognitive architectures that must operate over extended time horizons with diverse and evolving inputs.

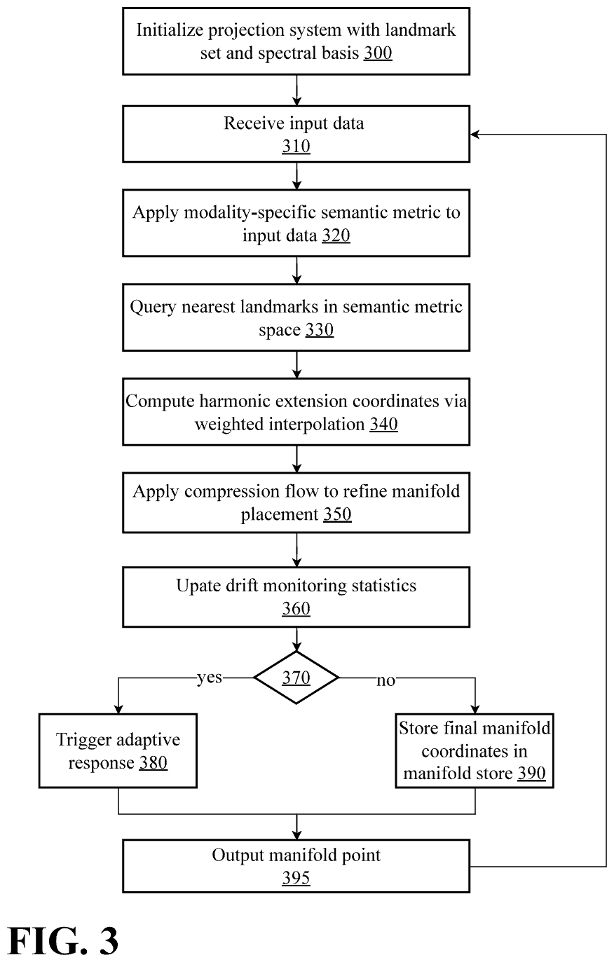

FIG. 3 is a flow diagram illustrating an exemplary method for adaptive geometric diffusion projection onto manifolds, according to an embodiment. The method 300 implements an operational pipeline of the adaptive geometric diffusion system, demonstrating how heterogeneous, high-dimensional inputs are transformed into coherent manifold coordinates while maintaining geometric stability through continuous monitoring and adaptation. Unlike conventional projection methods that operate in batch mode with periodic retraining, method 300 implements a streaming architecture with inline geometric validation, enabling continuous operation over indefinite time horizons without degradation.

According to the embodiment, the process begins at step 300 when the projection system initializes with a landmark set and spectral basis. This initialization process establishes the foundational geometric structure upon which all subsequent projections will be based. The initialization may comprise selecting an initial set of landmarks L from available data or prior knowledge, constructing a semantic kernel that captures relationships among landmarks, computing the graph Laplacian and its spectral decomposition to obtain eigenvalues and eigenvectors, and establishing the canonical coordinate system based on the top m eigenvectors selected by spectral gap analysis. For systems that are restarting rather than initializing fresh, this step may involve loading previously computed spectral bases and landmark sets from persistent storage, enabling continuity across system restarts.

In a step 310, the system receives input data from a cortex j, which produces a latent representation in the space S^{j}. This input may arrive as part of a continuous stream from one or more cortices operating in parallel, each generating representations with distinct dimensional and distributional characteristics. The receiving process extracts both the raw latent vector and any associated metadata that may inform the projection, such as the cortex identifier, timestamp, confidence measures, or semantic tags. The system maintains input buffers that can accommodate varying arrival rates from different cortices, ensuring that the projection pipeline can process heterogeneous streams without blocking or dropping data.

In a step 320, the system applies a modality-specific semantic metric to the input data. Each cortex type j has an associated semantic metric that captures the appropriate notion of similarity for that modality. For visual cortices, this metric may emphasize perceptual similarity based on learned features or handcrafted descriptors. For language cortices, the metric may incorporate syntactic structure, semantic relationships, or contextual embeddings. For temporal cortices, the metric may weight recent proximity more heavily than distant relationships. The application of these modality-specific metrics ensures that the subsequent landmark queries retrieve genuinely relevant reference points rather than spurious matches based on incidental coordinate proximity.

In a step 330, the system queries the L nearest landmarks in the semantic metric space. This query operation leverages efficient approximate nearest neighbor data structures such as hierarchical navigable small world graphs or inverted file indices that have been pre-built on the landmark set. The parameter L can be selected to balance computational efficiency with interpolation quality, typically ranging from 5 to 20 landmarks depending on the manifold's local complexity. The query returns not only the landmark identities but also their distances in the semantic metric, which will be used for weight computation in the subsequent interpolation step. This nearest neighbor query represents one of the few potentially costly operations in the pipeline, but its complexity remains logarithmic in the landmark set size, which itself is much smaller than the full manifold.

In a step 340, the system computes harmonic extension coordinates via weighted interpolation. Using the landmarks identified in the previous step and their semantic distances, the system calculates interpolation weights according to an exponential kernel with a modality-specific bandwidth parameter. These weights can be normalized to sum to unity, and the harmonic extension coordinates may be computed as the weighted barycenter of the landmark spectral coordinates. This computation has a closed-form solution requiring only vector operations, making it extremely efficient. The result is an initial placement in the manifold coordinate system that respects the semantic relationships to known landmarks while maintaining the smooth structure imposed by the spectral basis.

In a step 350, the system applies compression flow to refine the manifold placement. While harmonic extension provides a reasonable initial placement, local geometric inconsistencies may accumulate without correction. The compression flow implements a gradient descent on a geometric energy functional that balances semantic coherence, manifold curvature, local density, and coordinate chart conditioning. The flow operates in small steps projected onto the local tangent space to ensure that updates remain on the manifold. Typically, only one or two iterations are required to achieve satisfactory local geometry. The compression flow affects only the neighborhood of the new point, maintaining reduced processing complexity of the insertion operation. This local refinement ensures that the manifold maintains its geometric quality even after millions of insertions.

In a step 360, the system updates drift monitoring statistics. Throughout the projection pipeline, various geometric invariants and quality metrics are computed and tracked. These include, but are not limited to, residuals from the harmonic extension indicating how well the new point fits the existing landmark structure, local curvature estimates in the neighborhood of the new point, density measures to detect overcrowding or sparsity, principal angles between the current and previous spectral bases if refreshed, and spectral gap ratios indicating the stability of the dimensionality reduction. These statistics are maintained using streaming algorithms that require minimal memory while providing accurate estimates of distribution properties. The drift monitor aggregates these statistics to build a comprehensive picture of the manifold's health and the projection quality over time.

At decision point 370, the system evaluates whether any drift threshold has been exceeded. The drift monitor compares current statistics against predetermined thresholds that indicate when adaptation is necessary. These thresholds may be set conservatively to balance stability with responsiveness, typically triggering adaptation only when geometric invariants show significant degradation or when projection quality metrics indicate systematic errors. The thresholds may be adaptive themselves, tightening in regions of high confidence and relaxing when exploring novel areas of the latent space. If no threshold is exceeded, the system proceeds directly to storage; otherwise, it branches to the adaptive response subroutine.

In a step 380, when drift is detected, the system triggers an adaptive response appropriate to the type of drift observed. An adaptive response subroutine may begin with a decision, which categorizes the drift type based on which metrics exceeded thresholds. For spectral drift indicated by large principal angles, the system proceeds to perform a warm-started refresh of the spectral basis, using the previous eigenvectors as initial conditions for accelerated convergence. For coverage gaps indicated by high harmonic extension residuals, the projection system promotes new landmarks from recent high-residual points to improve representation in under-covered regions. For geometric degradation indicated by curvature or density violations, the projection system adjusts the parameters of the compression flow to restore geometric quality. Each adaptive response is designed to address specific failure modes while minimizing disruption to the overall projection pipeline.

The system updates relevant components based on the adaptive response. This may comprise broadcasting new spectral coordinates to all storage components, updating the nearest neighbor indices with new landmarks, or propagating adjusted parameters to the compression flow engine. The updates are designed to be incremental and local when possible, avoiding global recomputation that would violate the streaming complexity bounds.

In a step 390, the system stores the final manifold coordinates in the manifold store. The storage operation includes not only the m-dimensional coordinate vector but also associated metadata such as the originating cortex identifier, timestamp, semantic tags, and quality metrics. The manifold store is organized to support efficient neighborhood queries for future compression flow operations and maintains appropriate indexing structures for retrieval. The storage operation also triggers any necessary updates to dependent data structures, such as spatial indices or density estimators.

In a step 395, the system outputs the manifold point m ∈M, making it available to downstream components such as the thought cache in a PCM architecture or other cognitive processing modules. The output includes the coordinate representation that can be used for similarity computations, trajectory planning, or other geometric operations on the manifold. After output, the method returns to step 310 to process the next input, creating a continuous streaming loop that can operate indefinitely while maintaining projection quality through adaptive responses to drift.

By combining efficient harmonic extension with local compression flow and continuous drift monitoring, the method enables robust projection that maintains semantic coherence even under challenging conditions of heterogeneous, non-stationary input streams.

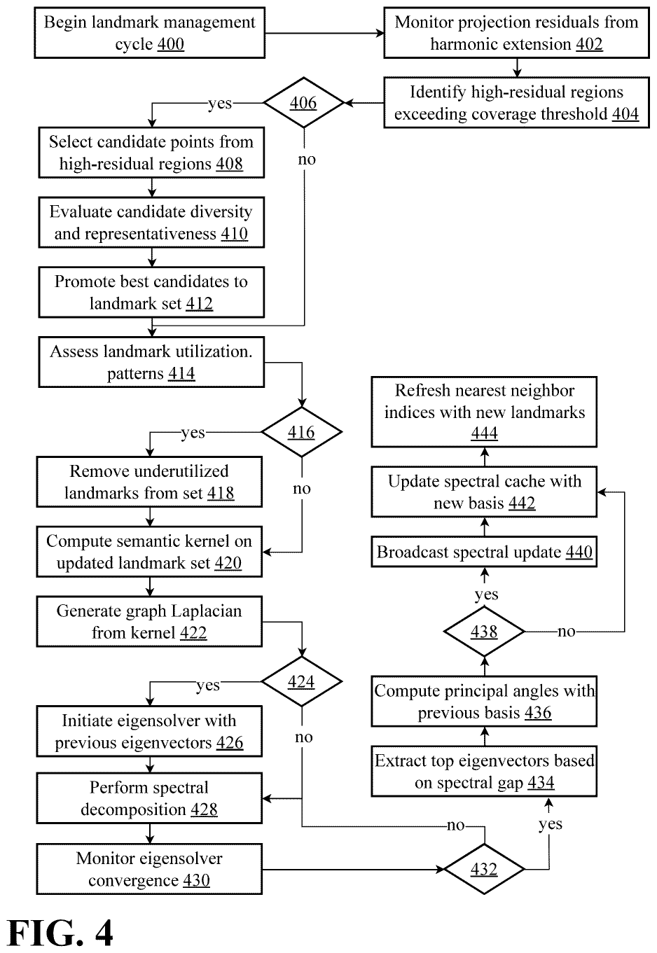

FIG. 4 is a flow diagram illustrating an exemplary method for landmark management and spectral update within the adaptive geometric diffusion system, according to an embodiment. The method 400 represents an adaptive maintenance procedure that updates the landmark set based on coverage analysis and refreshes the spectral basis to reflect these changes. This design ensures that spectral computations always operate on the most current landmark configuration, maintaining consistency between the landmark infrastructure and its spectral representation. Unlike static landmark selection methods that require periodic global recomputation, method 400 implements continuous monitoring with incremental updates, maintaining projection quality without disrupting ongoing operations.

According to the embodiment, the process begins at step 400 when the system begins a landmark management cycle. These cycles may be triggered either periodically based on elapsed time or data volume, or reactively when drift monitoring indicates potential coverage or quality issues. The landmark management cycle operates concurrently with the main projection pipeline, ensuring that projection operations can continue uninterrupted while the landmark infrastructure adapts to changing conditions. The cycle maintains state across iterations, tracking historical patterns of landmark utilization, residual distributions, and spectral stability to inform current decisions.

In a step 402, the system monitors projection residuals from harmonic extension operations. During normal projection operations, each harmonic extension produces a residual that indicates how well the new point can be represented by interpolation from existing landmarks. These residuals are aggregated using streaming statistical methods that maintain distributional information without storing individual values. The monitoring process tracks several residual statistics including the mean and variance of residuals across different time windows, quantile estimates particularly focusing on the tail behavior, spatial clustering of high residuals that may indicate systematic coverage gaps, and temporal trends showing whether residuals are increasing or decreasing. This continuous monitoring provides the primary signal for detecting when the landmark set requires adaptation.

In a step 404, the system identifies high-residual regions that exceed a coverage threshold. The identification process may utilize spatial hashing or clustering algorithms to group residuals by their location in the latent space, identifying contiguous regions where projection quality is consistently poor. The coverage threshold is set adaptively based on the global residual distribution, typically targeting a range (e.g., the top 1-5%) of residuals as candidates for improved coverage. Regions may be characterized not only by their residual magnitude but also by their persistence over time and the number of points affected, ensuring that landmark additions address systematic coverage gaps rather than isolated outliers.

At decision point 406, the system evaluates whether significant coverage gaps have been detected. This decision may consider both the absolute magnitude of residuals in identified regions and their impact on overall projection quality. If the high-residual regions affect a substantial number of recent projections or show persistent degradation over multiple cycles, the system proceeds to landmark promotion. Otherwise, it skips to landmark utilization assessment, avoiding unnecessary expansion of the landmark set.

In a step 408, when coverage gaps are confirmed, the system selects candidate points from high-residual regions. The selection process can be configured to balance several criteria to identify points that will effectively improve coverage, some examples of which include: centrality within the high-residual region to maximize coverage improvement, stability over time to avoid selecting transient outliers, diversity relative to existing landmarks to avoid redundancy, and representativeness of the local data distribution. The system typically selects multiple candidates per region, allowing subsequent evaluation to choose the most effective additions. Candidates are drawn from recent projection history, ensuring they reflect current distribution patterns rather than historical artifacts.

In a step 410, the system evaluates candidate diversity and representativeness. This evaluation prevents the landmark set from becoming unnecessarily large or redundant by ensuring each new landmark provides meaningful coverage improvement. The evaluation computes pairwise distances between candidates and existing landmarks in the semantic metric, estimates the coverage improvement each candidate would provide using a leave-one-out prediction approach, and assesses the stability of candidates by examining their neighborhood consistency over time. Candidates that are too similar to existing landmarks or each other are filtered out, while those providing maximal coverage improvement with minimal redundancy are retained.

In a step 412, the system promotes the best candidates to the landmark set L. The promotion process involves adding selected candidates to the active landmark set, computing their semantic relationships to existing landmarks for kernel construction, and updating auxiliary data structures that depend on the landmark set. The number of promotions in each cycle is bounded to prevent sudden expansions that could destabilize the spectral basis. Typically, the system promotes between 1% and 5% new landmarks per cycle when coverage gaps are detected, balancing improved coverage against computational costs.

In a step 414, the system assesses landmark utilization patterns to identify potential redundancy. Each landmark maintains utilization statistics tracking how often it appears among the nearest neighbors during harmonic extension, with what average weight it contributes to interpolations, and whether its removal would significantly impact projection quality. These statistics are maintained using exponential decay to emphasize recent patterns while retaining historical information. Landmarks that consistently show low utilization may be candidates for removal, helping to maintain a compact and efficient landmark set.

At decision point 416, the system determines whether underutilized landmarks are present. A landmark is considered underutilized if its utilization metrics fall below adaptive thresholds for an extended period. The decision considers not only current utilization but also historical importance and potential future relevance. Landmarks in sparse regions may show low utilization but remain important for coverage, while landmarks in dense regions with many alternatives may be safely removed. If underutilized landmarks are identified and their removal would not create coverage gaps, the system proceeds to landmark removal.

In a step 418, the system removes underutilized landmarks from set L. The removal process is conservative, ensuring that coverage quality is maintained. Before removal, the system verifies that neighboring landmarks can adequately cover the removed landmark's region and that no recent high-residual points would be affected by the removal. The removal is staged, with landmarks marked for removal but retained for one additional cycle to verify that their absence does not degrade projection quality. This conservative approach prevents oscillation between addition and removal of landmarks in boundary regions.

In a step 420, following any landmark set modifications, the system computes the semantic kernel K on the updated landmark set. According to an embodiment, the kernel construction uses the composite formula K(l, l′)=exp(−Σⱼ αⱼ d^{j}ₛₑₘ(l, l′)), combining semantic distances across all modalities with appropriate weights. For efficiency, only kernel entries affected by landmark additions or removals may be recomputed, leveraging the sparsity of updates. The kernel may be further sparsified by thresholding small values, reducing computational costs for subsequent operations while maintaining the essential connectivity structure.

In a step 422, the system generates the graph Laplacian L_{L} from the updated kernel. According to an embodiment, the Laplacian construction follows the normalized form

L_{L}=I−D^{-1/2}KD^{-1/2}, where D is the degree matrix. For incremental updates, the system can efficiently update the Laplacian by modifying only rows and columns corresponding to changed landmarks, avoiding full recomputation. The Laplacian is stored in a sparse format optimized for the subsequent eigenvalue computations.

At decision point 424, the system checks whether a previous spectral basis is available for warm-starting. In most operational cycles, a previous basis exists from earlier computations. This basis provides excellent initial conditions for iterative eigensolvers, dramatically reducing the number of iterations required for convergence. Only during initial system startup or after catastrophic changes would no previous basis be available, requiring cold-start initialization.

In a step 426, when available, the system initializes the eigensolver with previous eigenvectors. The warm-start procedure projects the previous eigenvectors onto the space of the updated Laplacian and orthonormalizes them to provide initial iterates. Because landmark changes are typically small relative to the total landmark set, these projected vectors are usually close to the true eigenvectors of the updated Laplacian. This warm-starting can reduce iteration counts by an order of magnitude compared to random initialization.

In a step 428, the system performs spectral decomposition via an iterative eigensolver. The solver, typically (but not necessarily) a Lanczos or locally optimal block preconditioned conjugate gradient (LOBPCG) method, computes the top r eigenvalue-eigenvector pairs of the Laplacian. The iteration leverages the sparse structure of the Laplacian and the warm-start initialization to achieve rapid convergence. The solver maintains numerical stability through periodic reorthogonalization and uses adaptive tolerance based on the spectral gap to avoid over-solving.

In a step 430, the system monitors eigensolver convergence through residual norms and eigenvalue stability. Convergence criteria include both absolute tolerance on the eigenvalue residuals and relative tolerance based on the spectral gap. The monitoring also tracks the number of iterations to detect potential conditioning issues that might require solver parameter adjustments.

At decision point 432, the system evaluates whether the eigensolver has converged to the specified tolerance. If convergence is not achieved within a maximum iteration budget, the solver parameters may be adjusted or the tolerance relaxed to ensure bounded computation time. However, warm-starting typically ensures rapid convergence except in cases of dramatic landmark changes.

In a step 434, the system extracts the top m eigenvectors based on spectral gap analysis. The selection of m is guided by identifying a significant gap in the eigenvalue spectrum, where λₘ+1−λₘ is large relative to adjacent gaps. This gap indicates a natural dimensional boundary in the data structure. The selected eigenvectors form the columns of the spectral coordinate matrix Ψ_{c} used for harmonic extension.

In a step 436, the system computes principal angles between the new and previous spectral bases. These angles, obtained through singular value decomposition of the basis inner products, quantify how much the spectral coordinates have rotated due to landmark updates. Small principal angles indicate stability, while large angles suggest significant structural changes in the data distribution that may require system-wide coordinate updates.

At decision point 438, the system evaluates whether any principal angle exceeds a stability threshold. For instance, typical thresholds may range from 5 to 15 degrees, balancing stability with adaptability. If all angles remain small, the spectral update can be considered a minor refinement that does not require global propagation. Large angles indicate a significant change that must be communicated throughout the system.

In a step 440, when significant spectral changes occur, the system broadcasts updates to all components. This broadcast includes the new spectral basis Ψ_{c}, updated eigenvalues for gap monitoring, rotation matrices for transforming old coordinates if needed, and timestamp information for consistency management. The broadcast ensures that all system components operate with consistent spectral coordinates, preventing discrepancies that could degrade projection quality.

In a step 442, the system updates the spectral cache with the new basis. The cache storage includes not only the current basis but also recent historical bases to support warm-starting and stability analysis. The cache implementation optimizes for rapid access during harmonic extension operations while maintaining the full precision necessary for numerical stability.

In a step 444, the system refreshes nearest neighbor indices with new landmarks. The index structures, such as HNSW graphs or IVF indices, must incorporate new landmarks and remove deleted ones while maintaining query performance. Incremental index updates leverage the local nature of most changes, modifying only affected neighborhoods rather than rebuilding globally.

Upon conclusion, the system returns to the main projection pipeline, having successfully adapted the landmark infrastructure to current conditions. The return includes updated handles and version information to ensure consistency. The entire landmark management and spectral update process is designed to operate concurrently with ongoing projections, providing seamless adaptation without service interruption.

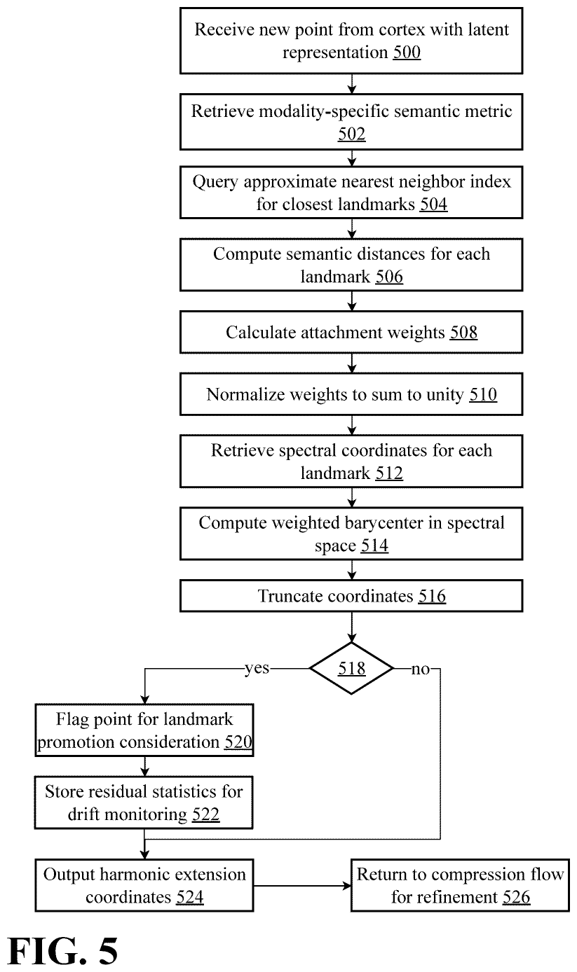

FIG. 5 is a flow diagram illustrating an exemplary method for harmonic extension enabling streaming attachment of new points to the manifold, according to an embodiment. The method 500 provides a mechanism by which the adaptive geometric diffusion system enables constant-time projection of new data points without requiring global recomputation or access to the full dataset. This harmonic extension process realizes a discrete Dirichlet problem, where new points are assigned coordinates that are harmonic with respect to the boundary conditions imposed by nearby landmarks. Unlike traditional manifold learning methods that require batch processing or iterative optimization, method 500 provides a closed-form solution that enables true streaming operation with bounded computational complexity.

According to the embodiment, the process begins at step 500 when the system receives a new point x from cortex j, where the point is represented as a high-dimensional vector in the latent space S^{j}. This input may arrive as part of a continuous stream from an active cortex, representing anything from visual features extracted by a convolutional network to semantic embeddings from a language model to temporal patterns from a sequence processor. The receiving process extracts not only the raw latent vector but also metadata identifying the source cortex, which is essential for applying the appropriate modality-specific processing in subsequent steps. The system maintains separate input channels for each cortex type, allowing parallel processing of heterogeneous streams while preserving modality-specific characteristics.

In a step 502, the system retrieves the modality-specific semantic metric associated with cortex j. Each cortex type has a carefully designed semantic metric that captures the appropriate notion of similarity for that modality. For a visual cortex, the metric might emphasize perceptual similarity based on color, texture, and shape features. For a language cortex, the metric might incorporate semantic relatedness, syntactic similarity, or contextual proximity. For a temporal cortex, the metric might weight recent observations more heavily than distant ones. These metrics are not simply Euclidean distances in the latent space but rather learned or designed dissimilarity functions that respect the semantic structure of each modality. The retrieval process accesses pre-computed metric parameters and function pointers optimized for efficient evaluation.

In a step 504, the system queries an approximate nearest neighbor (ANN) index to find the L closest landmarks to point x in the semantic metric space. The ANN index, which may be implemented as a hierarchical navigable small world (HNSW) graph or an inverted file (IVF) structure, has been pre-built on the landmark set and optimized for the specific semantic metric of each modality. The query process navigates the index structure to rapidly identify candidate landmarks without exhaustive comparison. The parameter L is chosen to balance interpolation quality with computational efficiency, typically (but not necessarily) set between 10 and 20 landmarks. This bounded neighborhood size ensures that the subsequent interpolation remains local and computationally tractable.

In a step 506, the system computes the exact semantic distances between the new point and each of the L retrieved landmarks. While the ANN index provides rapid approximate retrieval, the exact distances are needed for accurate weight computation. These distance calculations may involve complex operations depending on the semantic metric—for instance, computing optimal transport distances for distribution-valued representations or evaluating learned neural distance functions. The system leverages vectorized implementations and GPU parallelism where available to compute all L distances efficiently. The computed distances serve dual purposes: they determine interpolation weights for coordinate assignment and provide signals for coverage quality assessment.

In a step 508, the system calculates attachment weights using an exponential kernel for a modality-specific bandwidth parameter. The exponential kernel provides smooth decay with distance, ensuring that nearby landmarks contribute strongly to the interpolation while distant landmarks have negligible influence. The bandwidth parameter κj is tuned for each modality to reflect the typical scale of semantic variations, tighter bandwidths for modalities with fine-grained distinctions, looser bandwidths for modalities with coarser semantic structure. These parameters may be adapted over time based on observed distance distributions, maintaining appropriate localization as the data distribution evolves. The exponential form also ensures numerical stability and provides theoretical guarantees about the smoothness of the resulting interpolation.

In a step 510, the system normalizes the weights to sum to unity, converting the raw exponential values into proper convex combination coefficients. This normalization ensures that the subsequent barycentric coordinates lie within the convex hull of the landmark coordinates, preventing extrapolation artifacts that could place new points in poorly-charted regions of the manifold. The normalization is computed with care taken to handle numerical edge cases such as when all distances are large (resulting in near-zero weights) or when one distance is much smaller than others (resulting in near-singular weight concentration). The normalized weights represent the influence each landmark has on the final coordinate assignment.

In a step 512, the system retrieves the spectral coordinates Ψ_{c}(l) for each of the L landmarks involved in the interpolation. These coordinates have been pre-computed during the spectral decomposition phase and stored in the spectral cache for rapid access. Each landmark's coordinates consist of its values along the top m eigenvectors of the landmark graph Laplacian, providing its position in the canonical spectral embedding. The retrieval process is optimized for cache locality, as landmarks that are semantically close are likely to be accessed together repeatedly. The spectral coordinates represent the “boundary conditions” for the harmonic extension problem; the new point's coordinates must interpolate smoothly between these known positions.

In a step 514, the system computes the weighted barycenter in spectral space. This barycentric interpolation has a deep mathematical justification: it solves the discrete Dirichlet problem of finding coordinates that are harmonic (have zero Laplacian) on the new vertex while matching the landmark coordinates on the boundary. The computation is straightforward matrix-vector multiplication, with the normalized weights forming the coefficients and the landmark coordinates forming the columns. The result is a coordinate vector in the full r-dimensional spectral space that smoothly interpolates between the landmark positions based on semantic proximity. This closed-form solution avoids the iterative optimization required by many manifold learning methods.

In a step 516, the system truncates the coordinates to the first m dimensions, where m has been selected based on spectral gap analysis. While the full spectral decomposition may compute r>m eigenvectors for numerical stability and future flexibility, only the first m coordinates are retained for the final manifold representation. This truncation respects the natural dimensional boundary identified by the spectral gap, discarding coordinates along eigenvectors associated with small eigenvalues that primarily encode noise or fine-grained variations. The truncated coordinates Ψ(x)∈R^{m} represent the new point's position on the semantic manifold M.

At decision point 518, the system evaluates whether the extension residual exceeds a quality threshold. The residual measures how well the new point can be represented by interpolation from the available landmarks wherein high residuals indicate that the point lies in a region poorly covered by the current landmark set. The residual computation may involve comparing the reconstructed spectral coordinates against an independent embedding or evaluating the smoothness of the interpolation weights. The threshold is set adaptively based on the global distribution of residuals, typically targeting a range (e.g., the top 1-5%) as indicators of coverage gaps. This evaluation provides actionable feedback for the adaptive maintenance of the landmark set.

In a step 520, when the residual exceeds the threshold, the system flags the point for landmark promotion consideration. This flagging does not immediately promote the point to landmark status but rather adds it to a buffer of promotion candidates that will be evaluated during the next landmark management cycle. The flagging includes storing the point's coordinates, its residual value, and temporal information to track whether high residuals persist in this region over time. Points that consistently show high residuals across multiple observations are strong candidates for promotion, as they indicate systematic coverage gaps rather than isolated outliers.

In a step 522, the system stores residual statistics for drift monitoring, regardless of whether the individual residual exceeded the threshold. These statistics are maintained using streaming algorithms that update running estimates of mean, variance, quantiles, and other distributional properties without storing individual values. The statistics are segmented by modality and time window to detect both global drift and modality-specific changes. This continuous monitoring provides the signals necessary for adaptive system maintenance, triggering landmark updates or parameter adjustments when the statistical properties shift significantly.

In a step 524, the system outputs the harmonic extension coordinates Ψ(x), which represent the new point's position on the semantic manifold M. These coordinates are now ready for potential refinement by the compression flow engine and eventual storage in the manifold store. The output includes not only the m-dimensional coordinate vector but also metadata such as the interpolation weights (for potential reverse mapping), the extension residual (for quality tracking), and the landmark identities (for understanding the local manifold structure). These coordinates maintain the semantic relationships from the original high-dimensional space while providing a compact, geometrically coherent representation.

In a step 526, the system returns control to the compression flow engine for potential coordinate refinement. While harmonic extension provides a principled initial placement, local geometric optimization may improve the manifold quality by adjusting positions to better satisfy curvature, density, and smoothness constraints. The handoff includes all necessary context for the compression flow to operate efficiently on the local neighborhood of the new point. This modular design allows the harmonic extension to focus on rapid, streaming attachment while delegating fine-grained geometric optimization to specialized components.

By combining efficient approximate nearest neighbor search with weighted barycentric interpolation in spectral space, this method enables streaming attachment that is simultaneously fast, accurate, and theoretically grounded. The method's ability to process millions of points while maintaining consistent quality through residual monitoring and adaptive landmark promotion makes it uniquely suited for the demands of persistent cognitive architectures operating over indefinite time horizons.

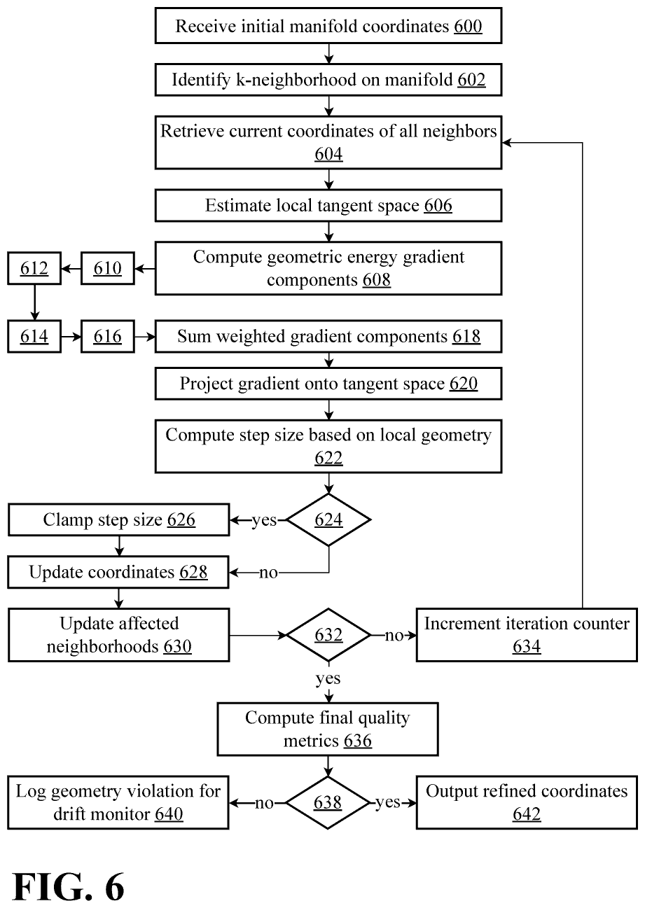

FIG. 6 is a flow diagram illustrating an exemplary method for compression flow refinement of manifold coordinates, according to an embodiment. The method represents a constrained geometric optimization process that refines the initial placement provided by harmonic extension to ensure local geometric coherence and global manifold quality. Unlike traditional manifold learning methods that perform global optimization or rely on fixed embedding algorithms, this method implements a local, adaptive flow that preserves the streaming nature of the projection while enforcing geometric constraints through explicit energy terms. This compression flow operates only on affected neighborhoods.

According to the embodiment, the process begins at step 600 when the system receives initial manifold coordinates from the harmonic extension module. These coordinates represent a first approximation of the new point's position on the manifold, obtained through weighted interpolation from nearby landmarks. While harmonic extension ensures smooth interpolation and respects the global spectral structure, it may not optimize for local geometric properties such as uniform density, bounded curvature, or well-conditioned coordinate charts. The compression flow refines these coordinates through a principled gradient flow that balances multiple geometric objectives while remaining constrained to the manifold. The initial coordinates serve as the starting point for this iterative refinement process.

In a step 602, the system identifies the k-neighborhood N(x) of the new point on the manifold. This neighborhood consists of the k nearest points in the current manifold representation, found through efficient spatial data structures such as k-d trees or ball trees built on the manifold coordinates. The neighborhood size k is chosen to capture sufficient local structure for meaningful geometric computation while remaining small enough to ensure efficient processing, typically (but not necessarily) between 10 and 30 neighbors. The neighborhood definition uses geodesic approximation through Euclidean distances in the manifold coordinates, which is accurate for smooth manifolds when neighborhoods are sufficiently small. This local focus is essential to the streaming nature of the algorithm, as it limits the scope of each update to a bounded region.

In a step 604, the system retrieves the current coordinates of all neighbors in N(x). These coordinates may be fetched from the manifold store, which maintains the current positions of all points on the manifold. The retrieval includes not only the coordinate vectors but also associated metadata such as point ages (how long since insertion), modality sources, and any special flags that might affect processing. The system can maintain these coordinates in a local working buffer during the flow iterations to minimize memory access overhead. For new points being inserted simultaneously in parallel threads, appropriate locking or conflict resolution ensures coordinate consistency.

In a step 606, the system estimates the local tangent space Tₓ M via principal component analysis (PCA) on the neighborhood coordinates. The tangent space approximation is crucial for ensuring that gradient updates remain on the manifold rather than drifting into the ambient space. The PCA computation proceeds by centering the neighbor coordinates around Ψ(x), computing the covariance matrix of the centered coordinates, and extracting the top m eigenvectors that define the local tangent directions. The tangent space estimate becomes more accurate as the manifold sampling density increases. For very sparse regions, the system may use regularized PCA or include additional distant neighbors to ensure stable tangent space estimation. This local linear approximation enables the projection of gradient vectors onto the manifold, maintaining the constraint that updated coordinates remain on M.

In a step 608, the system computes gradient components of the geometric energy functional. The total energy E(Ψ) balances multiple objectives that together encourage a well-formed manifold. Each component addresses a specific geometric concern and can be computed independently before combination. The modular design allows easy adjustment of the energy functional for different applications or manifold characteristics.

In a step 610, the system calculates the semantic coherence term ∇Eₛₑₘ. This gradient component encourages semantically similar points to remain close on the manifold while allowing semantically dissimilar points to separate. The computation involves evaluating pairwise semantic distances d^{j}ₛₑₘ between x and its neighbors, comparing these semantic distances to manifold distances ∥Ψ(x)−Ψ(y)∥, and computing gradients that reduce discrepancies between semantic and manifold proximities. The semantic coherence term prevents the manifold from developing arbitrary distortions that would destroy the semantic meaning of geodesics. The gradient is weighted by the reliability of semantic distances, giving more influence to high-confidence similarities.

In a step 612, the system calculates the curvature penalty term ∇E_{curv}. This gradient component discourages excessive local curvature that could lead to manifold folding or create numerical difficulties for downstream processing. The curvature estimation uses the positions and tangent spaces of neighboring points to approximate the second fundamental form. The gradient is computed to flatten regions of high curvature while preserving necessary bends that reflect true semantic boundaries. The system employs a soft penalty that allows moderate curvature but strongly penalizes extreme values that would violate smoothness assumptions. Mean curvature H and Gaussian curvature K may both contribute to this term, with separate weight parameters controlling their relative importance.

In a step 614, the system calculates the density regularization term ∇E_{dens}. This gradient component encourages uniform sampling density across the manifold, preventing both overcrowding and sparse regions. The density estimation uses kernel density estimation on the local neighborhood, with the gradient computed to move points away from high-density regions and toward low-density regions. This regularization serves multiple purposes: it improves the conditioning of local operations, ensures efficient use of the manifold's representational capacity, and prevents the formation of singularities. The target density may be uniform or may follow a prescribed distribution based on importance weights or semantic priorities.

In a step 616, the system calculates the chart conditioning term ∇E_{chart}. This gradient component ensures that local coordinate charts remain well-conditioned, preventing the development of degenerate mappings that would compromise the manifold's differentiable structure. The computation involves evaluating the Jacobian of the local parameterization, computing condition numbers or related metrics of distortion, and generating gradients that improve the local isometry between the manifold and its tangent space. Well-conditioned charts are essential for stable computation of geodesics, parallel transport, and other differential-geometric operations that may be required by downstream cognitive processes.

In some implementations of step 618, the system combines the weighted gradient components according to ∇E=αₛₑₘ ∇Eₛₑₘ+α_{curv} ∇E_{curv}+α_{dens} ∇E_{dens}+α_{chart} ∇E_{chart}. The weight parameters αᵢ control the relative importance of each objective and may be adapted based on the current state of the manifold or the specific requirements of different regions. For instance, regions with high semantic uncertainty might use lower αₛₑₘ, while regions approaching the injectivity radius limit might increase α_dens. The combined gradient represents the direction of steepest descent for the total geometric energy, pointing toward improved local manifold quality.

In a step 620, the system projects the gradient onto the tangent space Tₓ M to ensure updates remain on the manifold. This projection uses the orthogonal projector P_{T}=V V^{T}, where V contains the orthonormal basis vectors for the tangent space computed earlier. The projection removes any component of the gradient normal to the manifold, preventing updates from pushing points off the manifold surface. This constrained optimization is essential for maintaining the manifold structure—unconstrained gradient descent would quickly destroy the low-dimensional structure by allowing points to drift into the full ambient space. The projected gradient ∇E_{projected} represents the steepest descent direction within the manifold constraint.

In a step 622, the system computes an adaptive step size η based on local geometry and gradient magnitude. The step size selection balances rapid convergence with stability, using strategies such as the local Lipschitz constant estimated from neighbor gradients, the current curvature and injectivity radius, and backtracking line search if the energy increases. The step size may also incorporate momentum from previous iterations or use accelerated gradient methods for faster convergence. Adaptive step sizing is crucial for handling the varying geometric properties across different manifold regions—flat regions can accommodate larger steps, while highly curved or densely sampled regions require conservative updates.

At decision point 624, the system checks whether the computed step size exceeds safety thresholds that would risk violating geometric constraints. These thresholds are based on the local scale of the manifold, typically set as a fraction of the minimum neighbor distance or the estimated injectivity radius. Large steps could cause topology violations such as self-intersections or fold-overs that would be difficult to correct in subsequent iterations.

In a step 626, if the step size is too large, the system clamps it to a safe maximum value (e.g., ηₘₐₓ=0.1×local_{scale}). This conservative limit ensures that no single update can dramatically alter the local manifold structure. The clamping preserves the gradient direction while limiting the magnitude, maintaining stability at the cost of potentially requiring more iterations for convergence. The factor 0.1 is exemplarily chosen to provide a good balance between safety and efficiency across a wide range of manifold geometries.

In a step 628, the system updates the coordinates according to Ψ(x)←Ψ(x)−η ∇E_{projected}. This gradient descent step moves the point in the direction that reduces the geometric energy while remaining on the manifold. The update is applied to the working copy of coordinates to allow for potential rollback if the update degrades manifold quality. The negative sign follows the convention that gradients point uphill, so descent requires moving in the opposite direction.

In a step 630, the system updates affected neighbor coordinates to maintain consistency. While the primary update focuses on the new point x, the gradient computation may indicate that neighboring points should also adjust to accommodate the new insertion. These neighbor updates are typically smaller in magnitude and help maintain smooth local geometry. The system applies these updates carefully to avoid cascading changes that could propagate through the entire manifold. Only neighbors within a tight radius of x are updated, preserving the local nature of the refinement process.

At decision point 632, the system evaluates convergence criteria to determine whether to continue iterations. Convergence may be declared when the gradient magnitude falls below a threshold, the relative change in coordinates is negligible, the geometric energy shows no significant decrease, or a maximum iteration count is reached. The iteration limit, typically 2-5 for streaming operation, prevents excessive computation while ensuring meaningful refinement. The convergence criteria balance geometric quality with computational efficiency, accepting good-enough solutions rather than pursuing perfect optimization.

In a step 634, if convergence has not been achieved, the system increments the iteration counter and returns to step 604 to begin another refinement cycle. The iterative nature allows progressive improvement of the local geometry, with each iteration building on the previous updates. The system maintains momentum information across iterations to accelerate convergence in consistent gradient directions. The loop structure ensures that the refinement process remains bounded in complexity while adapting to the local geometric requirements.

In a step 636, upon convergence, the system computes final quality metrics including local curvature measures, minimum distances to neighbors (proxy for injectivity radius), condition number of the local chart, and residual energy values. These metrics serve both as quality indicators for the current refinement and as monitoring signals for the overall manifold health. The computation reuses much of the geometric information already calculated during the flow, adding minimal overhead.

At decision point 638, the system checks whether the computed geometric invariants fall within acceptable bounds. These bounds are set based on theoretical requirements for manifold regularity and empirical observations of stable operating regions. Violations might include excessive curvature that risks folding, critically small neighbor distances approaching the injectivity limit, or poorly conditioned charts that would cause numerical instabilities. The bounds may be adaptive, tightening in regions of high confidence and relaxing when exploring novel semantic territories.

In a step 640, if geometric invariants violate acceptable bounds, the system logs these violations for the drift monitor. While the compression flow has done its best to place the point appropriately, persistent violations may indicate the need for system-level adaptations such as landmark refresh, dimensionality adjustment, or parameter tuning. The logging includes the type and magnitude of violations, the affected region of the manifold, and relevant context about the input stream. These logs feed into the drift detection algorithms that trigger adaptive maintenance.

In a step 642, the system outputs the refined coordinates to the manifold store for persistence. The storage operation includes the final coordinate vector, quality metrics for monitoring, convergence information for debugging, and update timestamps for consistency. The manifold store indexes these coordinates for efficient retrieval during future neighbor queries. The output represents the system's best estimate of where the new point belongs on the semantic manifold, balancing global consistency through harmonic extension with local optimization through compression flow.

Upon completion, the system returns control to the main projection pipeline, having completed the refinement process. The return may comprise status information indicating successful refinement or warning flags if geometric constraints could not be fully satisfied. This modular completion allows the projection pipeline to continue with subsequent points while the refined coordinates are integrated into the broader cognitive architecture.

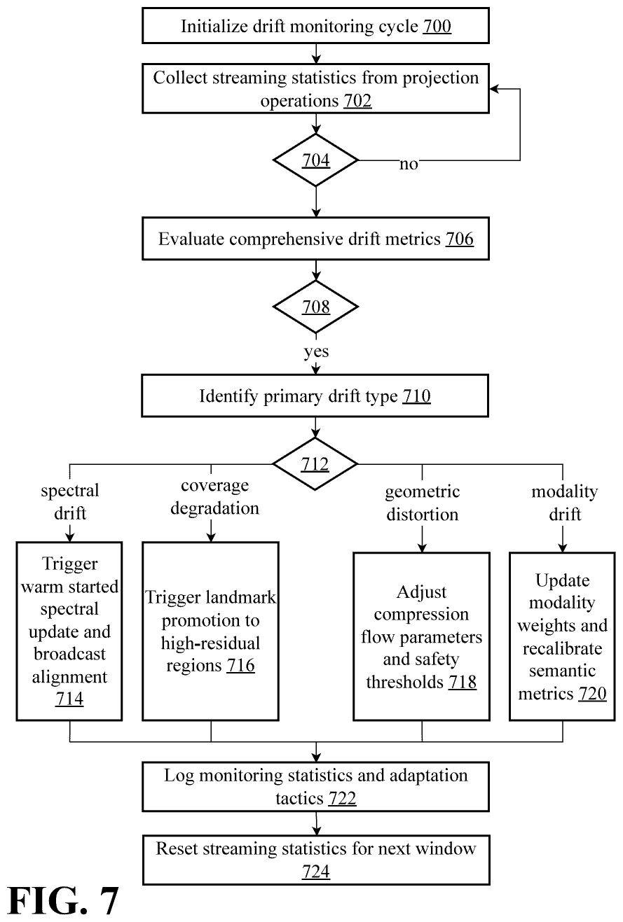

FIG. 7 is a flow diagram illustrating an exemplary method for drift monitoring and adaptive response within the adaptive geometric diffusion system, according to an embodiment. The method supports the continuous monitoring infrastructure that detects various forms of distributional drift and geometric degradation, triggering targeted adaptive responses to maintain projection quality over indefinite operational periods. This method implements autonomous detection and adaptation based on mathematically principled geometric invariants and statistical measures. This monitoring system operates concurrently with the main projection pipeline, providing real-time quality assurance without disrupting ongoing operations.

According to the embodiment, the process begins at step 700 when the system initializes a drift monitoring cycle. These cycles run continuously in the background, aggregating statistics over sliding temporal windows that balance responsiveness to change with statistical stability. The initialization establishes monitoring buffers for various metrics, sets temporal window parameters based on data arrival rates, resets accumulators for streaming statistics, and synchronizes with other system components to ensure consistent measurement periods. The monitoring cycle typically spans hundreds to thousands of projection operations, providing sufficient data for reliable statistical inference while remaining responsive to rapid changes in the input distribution.

In a step 702, the system collects streaming statistics from ongoing projection operations. Rather than storing raw data, which would be prohibitive at scale, the system maintains compact statistical summaries that can be updated incrementally. These statistics may comprise, but are not limited to, projection residuals from harmonic extension, convergence behavior of compression flow iterations, neighbor distance distributions on the manifold, computational costs for various operations, and success rates for geometric constraint satisfaction. The collection process is designed to have minimal overhead, piggybacking on computations already performed during normal projection operations. Each projection contributes its measurements to the appropriate streaming estimators without requiring additional passes over the data.

In a step 702, the system collects streaming statistics from ongoing projection operations. Rather than storing raw data, which would be prohibitive at scale, the system maintains compact statistical summaries that can be updated incrementally. These statistics encompass various categories including, but not limited to: residual distribution metrics tracking projection quality through harmonic extension residuals, spectral stability metrics monitoring the evolution of eigenvalues and eigenvectors, geometric invariant metrics characterizing manifold shape through curvature and injectivity measures, and modality reliability metrics assessing the consistency and quality of different cortical inputs. The collection process is designed to have minimal overhead, piggybacking on computations already performed during normal projection operations. Each category employs streaming algorithms such as Welford's method for moments, P-square for quantiles, and exponentially weighted averages for trends.

At decision point 704, the system determines whether the current monitoring window is complete. Window completion may be triggered by reaching a predetermined number of projections, elapsed wall-clock time, or detection of significant events that warrant immediate evaluation. The windowing strategy balances statistical reliability requiring sufficient samples against responsiveness to rapid changes. Adaptive windowing may shorten intervals when high variance is detected or lengthen them during stable periods to reduce computational overhead.

In a step 706, upon window completion, the system evaluates comprehensive drift metrics across all monitoring categories. This evaluation includes computing principal angles between the current spectral basis and reference bases to detect structural rotation, evaluating the spectral gap ratio (λₘ₊_{₁}−λₘ)/λₘ to ensure stable dimensionality reduction, assessing curvature distribution statistics to identify geometric distortion, calculating injectivity radius estimates based on minimum neighbor distances, and analyzing residual quantile trends to detect systematic coverage degradation. These metrics are computed efficiently using accumulated statistics rather than requiring passes over raw data. The comprehensive evaluation provides a multi-faceted view of system health, enabling detection of various drift modalities that might be masked by examining any single metric in isolation.

At decision point 708, the system evaluates whether any monitored metric exceeds its critical threshold. These thresholds are set based on theoretical requirements for manifold regularity, empirical stability boundaries, and adaptive percentiles of historical values. The thresholds implement a hierarchy of responses, with minor violations triggering increased monitoring and major violations initiating corrective actions. The evaluation considers not just individual metrics but also patterns across multiple indicators that might signal compound drift scenarios.

In a step 710, when critical thresholds are exceeded, the system identifies the primary drift type based on which metrics show the most significant violations. This categorization considers patterns across multiple indicators, temporal ordering of violations, and severity scores. The identification process may detect compound drift scenarios requiring multiple adaptations. Accurate drift classification ensures that subsequent adaptations address root causes rather than symptoms.

At decision point 712, the system branches to specific adaptation strategies based on the identified drift type, with each type requiring targeted corrective actions:

In a step 714, for spectral drift, the system triggers a warm-started spectral update using the processes described herein (e.g., FIG. 4). This may comprise preparing warm-start vectors from the current basis, computing the updated spectral decomposition, and broadcasting rotation matrices to align existing coordinates with the new basis. The warm-starting ensures efficient computation while the broadcast maintains system-wide consistency.

In a step 716, for coverage degradation, the system triggers landmark promotion to improve representation in under-covered regions. This process identifies high-residual areas from the accumulated statistics, selects representative candidates, and updates the landmark set as described herein. The targeted addition of landmarks addresses coverage gaps without unnecessarily expanding the landmark set globally.

In a step 718, for geometric distortion, the system adjusts compression flow parameters including the weights of different energy terms, step size limits, and safety thresholds. These adjustments target specific geometric issues—increasing curvature penalties in highly curved regions, strengthening density regularization where points cluster, or modifying convergence criteria to ensure geometric constraints are satisfied.

In a step 720, for modality drift, the system updates the relative weights αⱼ of different cortical inputs based on their reliability scores and recalibrates semantic metrics for drifting modalities. Modalities showing high residuals or inconsistency see reduced weights, while stable modalities gain increased influence. The recalibration adapts to changed distributional characteristics while maintaining backward compatibility.

In a step 722, the system logs comprehensive monitoring statistics and adaptation actions. This logging provides audit trails, enables offline analysis of drift patterns, and creates data for system improvement. The structured logs capture metric values, threshold violations, adaptation decisions, and outcome measures.

In a step 724, the system resets streaming statistics for the next monitoring window. The reset is selective, preserving long-term trends while clearing short-term accumulators. This ensures fresh measurements for each window while maintaining continuity for trend analysis. The system returns to main system operation, having completed the monitoring and adaptation cycle. The return may comprise status flags indicating any active adaptations and updated parameters propagated to relevant components.

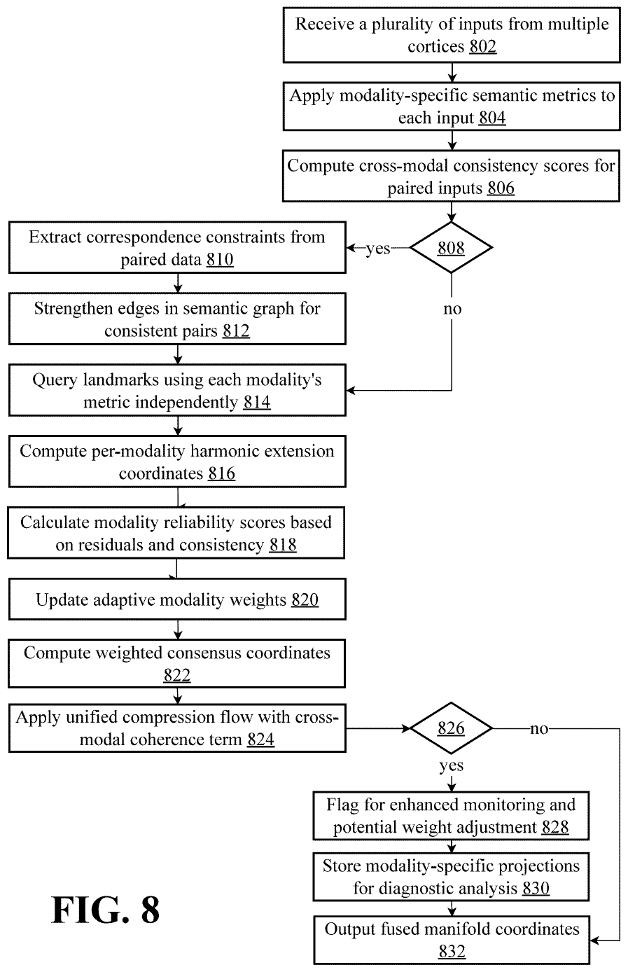

FIG. 8 is a flow diagram illustrating an exemplary method for multimodal fusion within the adaptive geometric diffusion system, according to an embodiment. The method represents a sophisticated process by which the AGD system combines heterogeneous inputs from multiple cortical sources into a unified manifold representation that preserves the semantic structure of each modality while discovering cross-modal relationships. The method implements a principled geometric fusion that adapts to the relative reliability and consistency of different modalities, enabling robust projection even when individual modalities are noisy, incomplete, or drifting. This multimodal capability is essential for cognitive architectures that must integrate diverse information sources such as visual, auditory, linguistic, and temporal signals into a coherent representation.

According to an embodiment, the process begins when the system begins the multimodal fusion process for inputs arriving from J different cortices. Each cortex represents a distinct processing pathway with its own latent space dimensionality, semantic structure, and reliability characteristics. The fusion process must accommodate cortices that may operate at different sampling rates, have varying levels of noise or uncertainty, represent complementary or redundant information, and experience independent distribution drift over time. The initialization prepares fusion buffers, synchronization mechanisms, and weight adaptation structures needed to handle this heterogeneity while maintaining computational efficiency.

In a step 802, the system receives concurrent inputs from multiple cortical sources. These inputs may arrive synchronously as part of a multimodal observation (e.g., simultaneous visual and auditory signals) or asynchronously as different cortices process information at different rates. The receiving mechanism maintains temporal alignment windows that group related inputs while accommodating processing delays. Each input carries metadata identifying its source cortex, timestamp, and any confidence measures provided by the cortical processing. The system buffers these inputs appropriately to enable both independent processing and cross-modal analysis.

In a step 804, the system applies modality-specific semantic metrics to each input. These metrics have been tailored to capture the notion of similarity appropriate to each modality—perceptual distance for vision, phonetic similarity for speech, semantic relatedness for language, or temporal proximity for sequential data. The application of separate metrics ensures that each modality's unique structure is respected rather than forcing all inputs through a common distance function that might lose important distinctions. The metrics may be pre-defined based on domain knowledge, learned from modality-specific training data, or adapted online based on observed statistics.

In a step 806, the system computes cross-modal consistency scores for inputs that may represent the same underlying entity or event across different modalities. For instance, a visual representation of an object and its spoken name should project to nearby regions on the manifold despite originating from different cortices with different latent representations. The consistency scoring examines temporal coincidence suggesting related observations, semantic correspondence based on known cross-modal relationships, and statistical correlation patterns learned from previous projections. These scores provide crucial information for aligning different modalities in the unified manifold.

At decision point 808, the system determines whether cross-modal pairs are available for the current inputs. In many scenarios, explicit pairing information exists—such as synchronized audio-visual streams or image-caption pairs. However, the system must also handle unpaired data where modalities operate independently. The presence of pairs enables stronger fusion through explicit correspondence constraints, while unpaired data relies more heavily on statistical alignment and semantic similarity.

In a step 810, when paired data is available, the system extracts correspondence constraints that will guide the fusion process. These constraints indicate that certain inputs across modalities should map to identical or nearby locations on the manifold. The extraction process identifies high-confidence pairs based on synchronization or explicit labeling, estimates the strength of correspondence based on pairing reliability, and prepares constraint edges for the semantic graph construction. These constraints provide powerful supervision for learning cross-modal alignments without requiring manual annotation.

In a step 812, the system strengthens edges in the semantic graph between points that show cross-modal consistency. The semantic graph, used in constructing the diffusion kernel, now includes both within-modality edges based on semantic similarity and cross-modality edges based on correspondence. Strengthening these edges ensures that the subsequent spectral decomposition will tend to place corresponding points nearby in the manifold representation. The edge weights are calibrated to balance within-modality structure preservation with cross-modal alignment, preventing any single modality from dominating the representation.

In a step 814, the system queries landmarks using each modality's metric independently. Rather than forcing a common metric across all modalities, which could lead to meaningless comparisons, each input finds its nearest landmarks among those originating from the same or compatible modalities. This modality-aware querying ensures that interpolation happens between semantically meaningful reference points. The system maintains separate approximate nearest neighbor indices for each modality, optimized for their specific metrics and query patterns. The number of landmarks L may vary by modality based on their individual complexity and coverage requirements.

In a step 816, the system computes per-modality harmonic extension coordinates. Each modality's input is projected independently using its own landmarks and interpolation weights, producing modality-specific coordinates Ψ^{j}x^{j}. This parallel processing respects the unique geometric structure of each modality while preparing for subsequent fusion. The independent projections also serve as diagnostic tools—large discrepancies between modality-specific projections of paired data indicate potential issues with metrics, landmarks, or data quality that warrant investigation.

In a step 818, the system calculates modality reliability scores based on projection quality indicators. These scores assess how well each modality is currently being represented by the projection infrastructure. Reliability metrics include average residuals indicating coverage quality, consistency of paired projections measuring cross-modal agreement, temporal stability of projections from the same modality, and concentration of interpolation weights suggesting landmark adequacy. Modalities experiencing distribution drift, sensor degradation, or poor landmark coverage receive lower reliability scores, reducing their influence in the fusion process.

In a step 820, the system updates adaptive modality weights αⱼ based on the computed reliability scores. These weights control the relative influence of each modality in constructing the fused representation. The update uses a soft combination of current reliability and historical performance, preventing rapid fluctuations while remaining responsive to genuine changes. The weights are normalized to sum to unity, ensuring that the fusion remains a proper convex combination. Adaptive weighting allows the system to gracefully handle scenarios where one or more modalities become temporarily unreliable without disrupting the overall projection quality.

In a step 822, the system computes weighted consensus coordinates using the formula Ψ_{consensus}=Σⱼ αⱼ Ψ^{j}(x^{j}). This weighted average combines the per-modality projections according to their current reliability, producing a unified representation that reflects the consensus across modalities. When modalities agree, the consensus naturally falls in their common projection region. When modalities disagree, more reliable modalities have greater influence in determining the final position. The consensus coordinates serve as the initial unified representation before refinement through compression flow.

In a step 824, the system applies a unified compression flow that includes a cross-modal coherence term in its energy functional. Beyond the standard geometric energy terms (semantic coherence, curvature penalty, density regularization, chart conditioning), the multimodal compression flow adds a term that encourages corresponding points from different modalities to remain nearby on the manifold. This term is weighted by the confidence in cross-modal correspondences and the reliability of the involved modalities. The unified flow ensures that the final manifold positions satisfy both within-modality geometric constraints and cross-modal alignment objectives.

At decision point 826, the system evaluates whether significant modality disagreement has been detected during the fusion process. Disagreement is measured by the spread of per-modality projections for supposedly corresponding points, violation of known cross-modal constraints, or anomalous patterns in the consensus computation. Significant disagreement may indicate sensor failures, distribution shift in specific modalities, or genuinely ambiguous inputs that admit multiple interpretations. The detection threshold is calibrated to distinguish meaningful disagreements from normal projection variance.

In a step 828, when significant disagreement is detected, the system flags the projection for enhanced monitoring and potential weight adjustment. The flagging mechanism alerts the drift monitoring system to pay special attention to the affected modalities and regions of the manifold. This may trigger accelerated weight adaptation to reduce the influence of problematic modalities, focused landmark addition in ambiguous regions, or diagnostic logging for offline analysis. The flags are propagated with the projection results to inform downstream processing that uncertainty may be elevated.

In a step 830, the system stores modality-specific projections alongside the consensus for diagnostic analysis. These individual projections provide valuable information for understanding system behavior, debugging fusion issues, and improving modality metrics or weights. The storage includes the per-modality coordinates Ψj, reliability scores and weight values, disagreement measures and flag states, and relevant metadata for trajectory analysis. This diagnostic information supports both online adaptation and offline system improvement without impacting the runtime efficiency of the fusion process.

In a step 832, the system outputs the final fused manifold coordinates resulting from the multimodal fusion process. These coordinates represent the system's best estimate of where the multimodal input should be positioned on the semantic manifold, taking into account all available modalities weighted by their reliability. The output maintains the low dimensionality m of the target manifold while capturing the essential semantic content from potentially dozens or hundreds of input dimensions across all modalities. The fused coordinates enable downstream processing that can leverage the full multimodal context without dealing with the complexity of heterogeneous representations.

The system returns control to the main projection pipeline upon completing the multimodal fusion. The return includes not only the fused coordinates but also metadata about the fusion process such as effective modality weights used, confidence measures based on agreement, and any warning flags raised during processing. This rich output enables the broader system to make informed decisions about how to use the projection while maintaining awareness of its reliability and provenance.

The methods and processes described herein are illustrative examples and should not be construed as limiting the scope or applicability of the manifold projection platform. These exemplary implementations serve to demonstrate the versatility and adaptability of the platform. It is important to note that the described methods may be executed with varying numbers of steps, potentially including additional steps not explicitly outlined or omitting certain described steps, while still maintaining core functionality. The modular and flexible nature of the manifold projection platform allows for numerous alternative implementations and variations tailored to specific use cases or technological environments. As the field evolves, it is anticipated that novel methods and applications will emerge, leveraging the fundamental principles and components of the platform in innovative ways. Therefore, the examples provided should be viewed as a foundation upon which further innovations can be built, rather than an exhaustive representation of the platform's capabilities.

### Exemplary Computing Environment

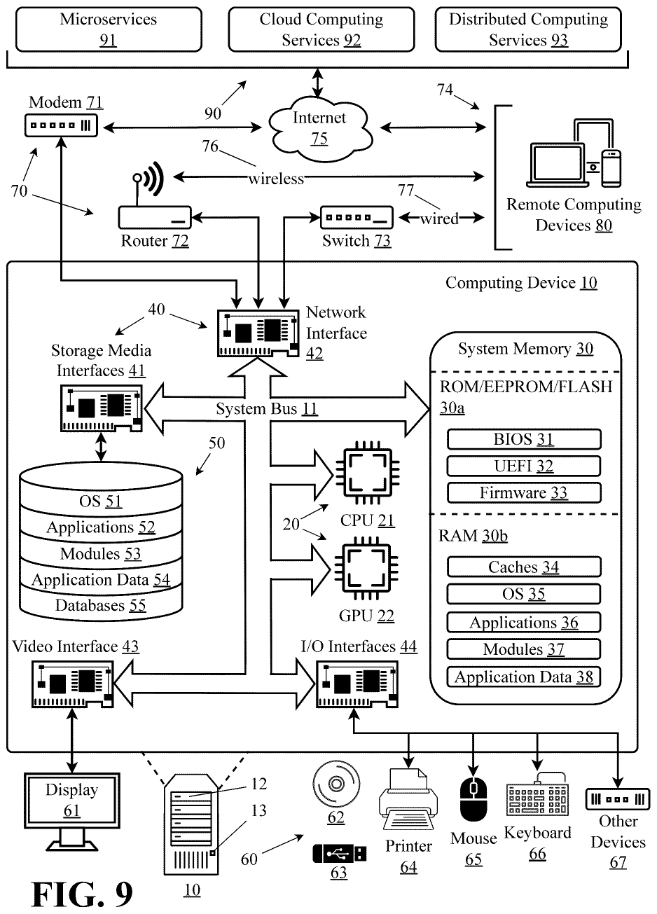

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A spectral learning system for a persistent cognitive machine, comprising:
a processor; and
a memory storing instructions that, when executed by the processor, cause the system to:
maintain a spectral decomposition of a cognitive manifold, the spectral decomposition comprising eigenvectors and eigenvalues that encode persistent long-term memory as global geometric structure;
perform inference operations by projecting incoming data onto the cognitive manifold using the spectral decomposition without modifying the spectral decomposition;
monitor geometric invariants that quantify structural adequacy of the spectral decomposition;
in response to a geometric invariant exceeding a threshold, execute a learning event comprising:
performing eigendecomposition of a graph Laplacian using warm-start initialization from the spectral decomposition;
enforcing mode-specific plasticity bounds that are tighter for low-frequency eigenvectors than for high-frequency eigenvectors; and
when the plasticity bounds are satisfied, replacing the spectral decomposition with an updated spectral decomposition; and
operate continuously by alternating between inference operations using a fixed spectral decomposition and learning events that modify the spectral decomposition through controlled spectral evolution;
wherein learning is realized through the controlled spectral evolution of the spectral decomposition.

2. The spectral learning system of claim 1, wherein the geometric invariants comprise at least one of: principal angles between the spectral decomposition and a previous spectral decomposition, spectral gap ratios computed from the eigenvalues, projection residuals measuring quality of the projection, or curvature statistics of the cognitive manifold.

3. The spectral learning system of claim 1, wherein performing inference operations comprises:
identifying landmark points near the incoming data based on a semantic distance metric;
computing weights based on the semantic distances; and
calculating manifold coordinates as a weighted combination of spectral coordinates of the identified landmark points.

4. The spectral learning system of claim 1, wherein the learning event further comprises:
updating a set of landmark points by promoting new landmarks from regions having high projection residuals; and
constructing the graph Laplacian from semantic relationships among the updated landmark points.

5. The spectral learning system of claim 1, wherein enforcing the mode-specific plasticity bounds comprises:
computing principal angles between updated eigenvectors and the eigenvectors of the spectral decomposition; comparing the principal angles against a maximum rotation threshold; and
rejecting the updated eigenvectors when the principal angles exceed the maximum rotation threshold.

6. The spectral learning system of claim 1, wherein enforcing the mode-specific plasticity bounds comprises:
computing eigenvalue drift magnitudes as differences between updated eigenvalues and the eigenvalues of the spectral decomposition;
comparing each eigenvalue drift magnitude against a mode-specific drift threshold; and
rejecting updated eigenvalues when eigenvalue drift for any low-frequency eigenvector exceeds a corresponding tight drift threshold.

7. The spectral learning system of claim 1, wherein the learning event further comprises:
computing an alignment transformation between the spectral decomposition and the updated spectral decomposition; and
transforming previously computed manifold coordinates using the alignment transformation to maintain continuity of geometric relationships.

8. The spectral learning system of claim 1, wherein the system is configured to:
receive incoming data from a plurality of heterogeneous data sources corresponding to different modalities;
maintain separate semantic distance metrics for each modality; and
compute modality-specific projections that are combined based on reliability weights.

9. The spectral learning system of claim 1, wherein the spectral decomposition encodes the persistent long-term memory as global geometric structure without requiring storage of individual data points or training examples.

10. A computer-implemented method for spectral learning in a persistent cognitive machine, comprising the steps of:
maintaining a spectral decomposition of a cognitive manifold, the spectral decomposition comprising eigenvectors and eigenvalues that encode persistent long-term memory as global geometric structure;
performing inference operations by projecting incoming data onto the cognitive manifold using the spectral decomposition without modifying the spectral decomposition;
monitoring geometric invariants that quantify structural adequacy of the spectral decomposition;
in response to a geometric invariant exceeding a threshold, executing a learning event comprising:
performing eigendecomposition of a graph Laplacian using warm-start initialization from the spectral decomposition;
enforcing mode-specific plasticity bounds that are tighter for low-frequency eigenvectors than for high-frequency eigenvectors; and
when the plasticity bounds are satisfied, replacing the spectral decomposition with an updated spectral decomposition; and
operating continuously by alternating between inference operations using a fixed spectral decomposition and learning events that modify the spectral decomposition through controlled spectral evolution;
wherein learning is realized through the controlled spectral evolution of the spectral decomposition.

11. The method of claim 10, wherein the geometric invariants comprise at least one of: principal angles between the spectral decomposition and a previous spectral decomposition, spectral gap ratios computed from the eigenvalues, projection residuals measuring quality of the projection, or curvature statistics of the cognitive manifold.

12. The method of claim 10, wherein performing inference operations comprises:
identifying landmark points near the incoming data based on a semantic distance metric;
computing weights based on the semantic distances; and
calculating manifold coordinates as a weighted combination of spectral coordinates of the identified landmark points.

13. The method of claim 10, wherein the learning event further comprises:
updating a set of landmark points by promoting new landmarks from regions having high projection residuals; and
constructing the graph Laplacian from semantic relationships among the updated landmark points.

14. The method of claim 10, wherein enforcing the mode-specific plasticity bounds comprises:
computing principal angles between updated eigenvectors and the eigenvectors of the spectral decomposition;
comparing the principal angles against a maximum rotation threshold; and
rejecting the updated eigenvectors when the principal angles exceed the maximum rotation threshold.

15. The method of claim 10, wherein enforcing the mode-specific plasticity bounds comprises:
computing eigenvalue drift magnitudes as differences between updated eigenvalues and the eigenvalues of the spectral decomposition;
comparing each eigenvalue drift magnitude against a mode-specific drift threshold; and
rejecting updated eigenvalues when eigenvalue drift for any low-frequency eigenvector exceeds a corresponding tight drift threshold.

16. The method of claim 10, wherein the learning event further comprises:
computing an alignment transformation between the spectral decomposition and the updated spectral decomposition; and
transforming previously computed manifold coordinates using the alignment transformation to maintain continuity of geometric relationships.

17. The method of claim 10, further comprising:
receiving incoming data from a plurality of heterogeneous source spaces corresponding to different modalities;
maintaining separate semantic distance metrics for each modality; and
computing modality-specific projections that are combined based on reliability weights.

18. The method of claim 10, wherein the spectral decomposition encodes the persistent long-term memory as global geometric structure without requiring storage of individual data points or training examples.
